(19) United States
(12) Patent Application Publication
(10) Pub. No.: US 2019/0188411 A1
(43) Pub. Date: Jun. 20, 2019

(54) Systems and Methods for Decentralizing Consumer Preferences, Consent and Permissions Management with Reward and Reputation Network for Enterprises Using a Blockchain Ledger

(71) Applicant: Vladislav Kroutik, San Diego, CA (US)

(72) Inventor: Vladislav Kroutik, San Diego, CA (US)

(21) Appl. No.: 15/847,717

(22) Filed: Dec. 19, 2017

(51) Int. Cl. G06F 21/62; G06F 21/60; H04L 29/06; G06F 21/64; G06Q 20/38

(52) U.S. Cl. CPC G06F 21/6245; G06F 21/604; H04L 63/08; H04L 9/3231; H04L 63/10; G06Q 20/3827; G06F 21/645

(57) ABSTRACT

This invention relates generally to a method and an apparatus for managing consumer preferences, consent and permissions (PCP) and more specifically to a decentralized infrastructure and system including enterprise access to specific consumer PCP within reward and reputation network utilizing Blockchain ledgers.

### BACKGROUND

### Technical Field

This invention relates generally to a method and an apparatus for managing consumer preferences, consent and permissions (PCP) and more specifically to a decentralized infrastructure and system including enterprise access to specific consumer PCP within reward and reputation network utilizing Blockchain ledgers.

### Background Art

2017 marks a new era of data breaches and identity theft, with high profile cases like Yahoo, Equifax, Uber just to name few. The governments across the world are striking back with more stringent data protection regulations, such as General Data Protection Regulation (GDPR) in European Union (EU) and similar regulations are in works in the United States and other countries across the globe. On the one side, consumers face unprecedented levels of data theft, privacy violations and feel increasingly violated and vulnerable, while at the same time, businesses are facing the challenge of higher complexity to securely store and protect consumer preferences, consent, permissions and private data.

A massive amount of consumer data is collected and consumer privacy is at stake around the world. The Internet has emerged as an important tool for commerce, communications and advertising for all businesses. Businesses of all sizes, small and large collect and store more and more data on users. At the same time the wave of data breaches continues to roll on. Data breaches have gained widespread attention as businesses of all sizes become increasingly reliant on digital data, cloud computing, and workforce mobility. With sensitive business data stared on local machines, on enterprise databases, and on cloud servers, breaching a company's data has become as simple—or as complex—as gaining access to restricted networks.

Data breaches did not only begin when companies began storing their protected data digitally. In fact, data breaches have existed for as long as individuals and companies have maintained records and stored private information. There is a need to impose a wide range of requirements on organizations that collect or process personal data, including a requirement to comply with five key principles.

One—transparency, fairness, and lawfulness in the handling and use of personal data, Businesses will need to be clear with individuals about how they are using personal data and will also need a “lawful basis” to process that data.

Two—limiting the processing of personal data to specified, explicit, and legitimate purposes. Businesses will not be able to re-use or disclose personal data for purposes that are not “compatible” with the purpose for which the data was originally collected.

Three—minimizing the collection and storage of personal data to that which is adequate and relevant for the intended purpose. Ensuring the accuracy of personal data and enabling it to be erased or rectified. Businesses will need to take steps to ensure that the personal data they hold is accurate and can be corrected if errors occur.

Four—limiting the storage of personal data. Businesses will need to ensure that they retain personal data only for as long as accessary to achieve the purposes for which the data was collected.

Five—ensuring security, integrity, and confidentiality of personal data. Businesses must take steps to keep personal data secure through technical and organizational security measures.

There is thus a need for an improved method and system to enable consumer to manage preferences, consent and permission on their terms, and provides enterprises with the means of safely accessing consumer private data within a system that gives consumer a strict control on what personal data is stored and how it is used; enabled by data governance tools for better transparency, record keeping, and reporting; data policies to provide consumer with control to data subjects and ensure lawful access; and provides a feedback system to enterprises and consumers white managing their reputation within the network.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a schematic block diagram illustrating a PCP management system in accordance with the invention.

FIG. 2 illustrates one embodiment of a block diagram showing a controller with the invention.

FIG. 3 illustrates one embodiment of a block diagram showing an enterprise interface accordance with the invention.

FIG. 4 illustrates one embodiment of a block diagram showing a consumer interface in accordance with the invention.

FIG. 5 illustrates one embodiment of a method for generating a smart contract in accordance with the invention.

FIG. 6 illustrates one embodiment of a method for a PCP selection by an enterprise in accordance with the invention.

FIG. 7 illustrates one embodiment of a method for an acceptance of a smart contract by a decentralized controller in accordance with the invention.

FIG. 8 illustrates one embodiment of a method for an activation of a smart contract in accordance with the invention.

FIG. 9 illustrates one embodiment of a method for maintenance of active smart contract in accordance with the invention.

FIG. 10 illustrates one embodiment of a method for selecting a smart contract by an enterprise in accordance with the invention.

FIG. 11 illustrates one embodiment of a method for binding of an enterprise execution commitment in response to a smart contract in. accordance with the invention.

FIG. 11 illustrates one embodiment of a method for binding of an enterprise commitment offer in response to a real estate option offer in accordance with the invention.

FIG. 12 illustrates one embodiment of a method for completing a smart contract between an enterprise and consumer in accordance with the invention.

FIG. 13 illustrates one embodiment of a method for implement a Blockchain in accordance with the invention.

FIG. 14 illustrates one embodiment of a method for implementing reward sharing by consumer in accordance with the invention.

FIG. 15 illustrates one embodiment of a method for implementing smart o n by a consumer in accordance with the invention.

FIG. 16 illustrates one embodiment of a method for implementing payment distribution in accordance with the invention.

FIG. 17 illustrates one embodiment of a method for implementing counteroffer by an enterprise in accordance with the invention.

FIG. 18 illustrates one embodiment of a method for accepting counteroffer by a consumer in accordance with the invention.

FIG. 19 illustrates one embodiment of a schematic block diagram illustrating a method of personal data, preferences, consent and permission management system in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to management of personal data, preferences, consent and permissions of consumers and conditional access by one or more enterprises. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The terms “comprises,” “comprising,” or any other variation thereof, are intended to cover a non-exclusive inclusion, such that a process, method, article, or apparatus that comprises a list of elements that does not include only those elements but may include other elements not expressly listed or inherent to such process, method, article, or apparatus. An element proceeded by “comprises . . . a” does not, without more constraints, preclude the existence of additional identical elements it the process, method, article, or apparatus that comprises the element.

Embodiments of the invention are now described in detail. Referring to the drawings, like numbers indicate like parts throughout the views. As used it the description herein and throughout the claims, the following terms take the meanings explicitly associated herein, unless the context clearly dictates otherwise: the meaning of “a,” “an,” and “the” includes plural reference, the meaning of “in” includes “in” and “on,” Relational terms such as first and second, top and bottom, and the like may be used solely to distinguish one entity or action from another entity or action without necessarily requiring or implying any actual such relationship or order between such entities or actions.

Embodiments of this invention relate generally to a method and apparatus to address the unfulfilled needs to securely store and manage consumer preferences, consent and permissions and grant access to enterprises on case by case basis with a consumer consent. We developed a method and a system by which one can apply Blockchain-based platform to PCP network with reward and reputation management.

Embodiments of the invention also facilitate creation and storing of PCP by consumer. This system includes facilitation of enterprise gaining a permission to access consumer PCP. Embodiments of the invention allow enterprises to reward consumers for using their personal data or the engagement with the enterprise

Embodiments of the invention also allow consumers to rate their experience the enterprises and vice versa, thus building qualitative feedback system that affects network participant's reputation. One advantage of one embodiment of the invention is that the PCP access is verified and recorded on the Blockchain ledger thus eliminating personal data misuse, theft and fraud and provides consumer with non-editable tracking of their PCP access by the enterprises.

In one embodiment, communications between enterprises and consumers are conducted using an electronic network and decentralized controller. The term “consumers” will be used herein to refer to either to consumer of enterprise's websites or enterprise's applications. The term preferences, consent and permission “PCP” will be used to refer to any private data created by consumer and shared with enterprises either electronically or physically.

An enterprise who wishes to reach one of the consumers PCP, accesses the decentralized controller, which may be located at a remote server across a network. The enterprise then creates a smart contract (SC) to access consumer PCP for a reward. The reward maybe realized when the consumer PCP is accessed and used by enterprise in the initial smart contract, the enterprise and consumer may negotiate SC expiration date, reward structure, and other conditions as required by the enterprise.

By way of example, let us take an enterprise “NewStyles.com” with a website that publishes articles on latest trends in clothing. The enterprise allows consumers to register on the website and share preferences for closing and consent to receive promotional advertising in exchange for rewards.

To create SC based on this example, the enterprise creates the reward offer to pay $1 for each engagement with a promotional video for the next four weeks. The consumer accepts the reward offer and consent to engage with enterprise. The SC is created and recorded on the Blockchain.

Once the consumer, Anna, who consented to receive advertisement for new fashion, watches the promotional video from HotLook on NewStyles.com, the SC is executed and the record is created on the Blockchain. The enterprise pays out $1 to the consumer. By one embodiment of the invention described later the payout can be in virtual tokens and not currency. By another embodiment, Anna likes the video and gives it thumbs up, positive reviews increase the enterprise's reputation.

Once the SC has been created, the enterprise then attaches consumer identification to the SC. The SC is then transmitted to the decentralized controller across the network. Examples of transmission schemes of the present invention include a world-wide-web interface, such as a web browser or portal, application programming interface (API), electronic snail, voice mail, facsimile, or postal mail. The system may attach standard legal provisions and boilerplate language to the SC, and may further “fill in the gaps” to complete the SC.

Once the verification process is complete, the decentralized controller then assigns a unique tracking number to the SC. The SC is then stored so that it becomes available for access by the enterprise. The SC may be categorized with other SCs, perhaps by consumer interests or many other targeting criteria, to make it easier for enterprise to identify relevant SCs.

If, after reviewing a particular SC, an enterprise wishes to participate in the SC, the enterprise communicates his interest to the decentralized controller. The decentralized controller then timestamps the interest message and authenticates the identity of the enterprise, as well as its capacity to deliver the consumers rewards set forth in the SC. The decentralized controller then verifies that the SC is “active” and available for execution, if a SC is available for execution only (MCC, it is “convicted” with the first execution by enterprise. Subsequent access by enterprise will be restricted in a “completed” SC.

If a SC is available for execution many times by enterprise subsequent execution will be granted to the enterprise in the same SC until the goals set forth in the SC are obtained. One the goals are reached, the SC is anted “completed”. When an enterprise participates in an active SC, the decentralized controller assigns a unique tracking number to the enterprise's participation. The execution details are then stored in a database. Once execution is confirmed, the consumer and enterprise become parties to a legally binding contract.

In one embodiment, the decentralized controller selects SC to present to enterprise's consumer based on his or her targeted criteria and interests specified, namely preferences. When consumer engages with SC, the decentralized controller creates the record on the Blockchain ledger to store the fact that SC was executed as a smart contract.

In a number of embodiments, the smart contract uses the Blockchain ledger and is stored and verified in a decentralized fashion, i.e. replicated to different entities (that may be referred to as nodes) that are separately able to verify past transactions. In further embodiments, the smart contract can be proven using cryptographic principles. In many embodiments, the chaining of transactions, cryptographic verification and the hash challenge utilizes a Blockchain system based on principles and/or mechanisms similar to those in the art a cryptocurrency. Techniques for managing Blockchains in the context of currency are described in “Bitcoin: A Peer-to-Peer Electronic Cash System” by Satoshi Nakamoto, published in 2008, the disclosure of which relevant to Blockchain management is hereby incorporated by reference in its entirety.

A Blockchain can typically be understood to be a distributed database that maintains a continuously-growing list of records called blocks. Each block contains a link to a previous block generated using a hash of the previous block, and often includes mechanisms for protection from tampering and revision. The Blockchain is distributed so that copies are replicated among participating nodes in the system. As transactions are added the copies are extended and the longest chains are trusted that follows a rule and provide according proof of work or stake. Nodes may be any of a variety of hardware devices, such as, but not limited to, servers, workstations, desktop computers, mobile devices, and/or tablets, configured to participate in the decentralized PCP management system as discussed further below. More specifically, nodes can include Blockchain management devices as described in greater detail further below.

In another embodiment, the decentralized controller manages reward payments between the enterprise and consumer automatically. Various methods of payment may be used in accordance with the invention, including payment by credit cards, personal checks, electronic funds transfer, debit cards, digital cash and virtual coin. The payment system may also involve the use of an escrow account associated with the SC wherein a trustee maintains funds advanced by the parties until the SC is complete. Moreover, payment timing may be varied, depending upon application.

In another embodiment of the invention, enterprise may be given an option of responding to a SC by issuing a counteroffer with conditions different from the original. In such a scenario, the enterprise transmits the counteroffer to the decentralized controller. The decentralized controller, au turn, forwards the counteroffer to the consumer. Upon receiving the counteroffer, the consumer is given the option of accepting the counteroffer. Where the counteroffer is accepted, the enterprise becomes bound to the consumer for the terms of the counteroffer.

In one embodiment, the SC may be constructed to pay rewards. The rewards may be used to enhance the attractiveness of a SC and reward consumers for engaging with the enterprise. Where rewards are used, the decentralized controller maintains rewards obligations as SCs and facilitates transactions required for payment. The decentralized controller may also record rewards payments on the Blockchain ledger.

While one embodiment of the present invention is intended for networked use, embodiments of the present invention may also take off-line forms. Instead of using electronic mail or web-based servers, for example, consumers and enterprises may communicate with the decentralized controller via telephone, facsimile, postal mail, or another off-line communication tool. For instance, consumers may use telephones to create SCs (with or without the assistance of live agents). Similarly, potential enterprises may use a telephone to browse and commit to SCs.

In one embodiment, security protocols are used. For example, cryptographic protocols may be used to authenticate the identity of enterprises and consumers, as well as to verify the integrity of electronic communications, SCs and all records with the decentralized controller and the Blockchain ledger. Using cryptography or other technologies such as biometrics, the decentralized controller can make it significantly more difficult for unauthorized persons to tamper with the system.

Similarly, the system in one embodiment works to maintain participant's anonymity. For numerous privacy and competitive reasons, participants often prefer not to have their identities revealed to the general public when engaging in commercial transactions. Embodiments of the invention offer such protection through the use of identification numbers stored in a database and the Blockchain ledger secured by the decentralized controller.

One embodiment of a decentralized controller suitable for use with the invention includes three controller components, which embody the Blockchain and six systems: a membership system, a reward management system, PCP management system, a SC system, a clearing system and a reporting system. The Blockchain ledger records executed SCs. The membership system authenticates the identity of enterprises and consumers. The PCP management system manages the consumer's preferences, consent and permissions. The reward management system manages all rewards from enterprises and matching it to consumer's interests. The SC system manages and stores SCs. The SC system facilitated creation of the SC and also executing and recording on the Blockchain. The clearing system is configured to process financial transactions associated with the rewards. The reporting system stores a log of all activities in the decentralized controller and performs on-demand reports. This multi-system configuration allows for ease of controller distribution among specialized servers.

Where disputes arise, one embodiment of the invention offer a mechanism for dispute resolution. In one embodiment, the system stores SCs on the Blockchain. The Blockchain may serve as an arbitrator or may refer the dispute to a third-party arbitrator for resolution.

Embodiments of the invention provide advantages not found in the prior art. First, the system provides the ability for enterprises consumers PCP by executing SCs for consumers who are interested in specific subject, topic or interest or wants to engage with the enterprise. Second, the system provides the ability for consumers to insure that SC execution is tracked and can be easily verified as it is stored on the Blockchain. Next, the system allows consumers to protect their privacy and private data. Forth, the system allows consumers to receive compensation utilizing opt-in engagement with enterprises which is tied to rewards. Lastly, the system uses reputation management that allows all participants to rate the quality of the transaction. Transaction costs are minimal, and the system provides trusted environment for management of consumer PCP with a smart contract (SC).

It is a goal of embodiments of the present invention to provide a robust system that protects consumer private data and enables consumer direct access to their preferences, giving them control over communications channels and specific communications subjects. The power of a decentralized controller to manage data access utilizing smart contracts between enterprises and consumers, execute those contracts globally in a format which can be efficiently accessed and analyzed by other, effectuate performance of resulting engagement with consumer by enterprises, recording engagement on the Blockchain, resolve disputes arising from those transaction, and maintain billing, collection, authentication, and anonymity makes the present invention an improvement over conventional systems.

As will be illustrated and described here an electronic system for decentralized preferences, consent and permissiosn management with reward and reputation network for enterprises using a Blockchain ledger creating SC for conditional access to consumer private data, between consumer and at least one of a plurality of enterprises is provided. The system includes a decentralized controller having a network interface coupled to a network. The decentralized controller includes and facilitates SC system configured to process execution of the smart contracts. The decentralized controller also includes an enterprise interface coupled to the network interface across the network. The enterprise interface is configured to receive enterprise input. A consumer interface, which is a part of the decentralized controller and is coupled to the network interface across the network, is configured to receive consumer input.

The decentralized controller further comprises PCP management system that is configured process consumer requests received by the electronic system to manage consumer PCP. The reward management system is further configured to deliver one or more rewards in response to the consumer requests. The reward management system also is configured to process SC reward requests received by the electronic system for SC rewards.

A SC system, also a part of the decentralized controller, is onfigured to process transactions associated with the smart contract (SC) and record those transactions on the Blockchain ledger. A reporting system maintains records of decentralized controller transactions. A SC system configured to process requests by enterprise to initiate a SC.

The Blockchain communication coupling, which may be connected to the decentralized controller across the network between the decentralized controller and the Blockchain, is configured to receive and record transaction when SC is created and executed.

A membership system, which is included in one embodiment of the decentralized controller, works with an enterprise database and a consumer database to authenticate an identity of at least one enterprise and at least one consumer by matching identities of enterprises stored in the enterprise database with certain enterprises. And the membership system may also match identities of consumers stored in the consumer database with other certain consumers.

A PCP database, which is accessible by the decentralized controller, is configured to store and access the consumer PCP. The SC system is configured to create a plurality of SCs corresponding to the PCP with a help of PCP system, and to store them in a SC database. In one embodiment, the PCP database comprises a plurality of databases, accessible by the decentralized controller. The plurality of databases can include at least a preference, consent and permission database for storing consumer private data and information associated with it, a SC database for storing the terms of a smart contract, a rewards database for storing rewards data relating to the smart contract. Other databases may be included as well, each database being accessible by the decentralized controller, including at least a reputation database for storing participant's feedback on transactions, a payment database for storing transaction data relating to the payments distribution, an escrow database for storing rewards and payments which awaiting distribution, and a transaction database for storing transactions detailing consumer's engagement with reward. Additional databases include an account database and an audit database.

The decentralized controller, upon receiving a request from the consumer interface, is configured to invoke the reward management system to retrieve one or more rewards from the rewards database, associate a rewards with the one or more engagement, and to deliver the offer to the consumer interface. Upon consumer engaging, receiving a confirmation from the consumer interface, the decentralized controller is configured to invoke the SC system to generate an identifier specifying at least a financial account. The identifier is associated with the engagement, which is stored with the identifier in the transaction database. Once the engagement is stored in the transaction database, the decentralized controller is configured to invoke the SC system to store the record on the Blockchain, execute associated SC and record the rewards in reward database.

A method for creating, managing, and executing smart contract, between an enterprise and at least one of a plurality of consumers, is also described. The steps of the method include providing a networked, electronic, exchange apparatus having a decentralized controller, as described above, and creating electronic smart contract via consumer interface, where the electronic smart contract comprising at least a personal data, preferences, consent and permissions. Once the smart contract is received, the decentralized controller performs the step of generating a SC associated with the electronic smart contract and delivers the smart contract to the enterprise interface. In one embodiment, the smart contract comprises at least a personal data, consent, preferences, minimum reward and an expiration date.

The enterprise then gets involved and transmit, through the enterprise commitments. Thus, the decentralized controller performs the step of receiving at least one execution commitment from the enterprise interface in response to the step of delivering the smart contract. The decentralized controller also receives an electronic financial account identifier associated with the at least one execution commitment from the enterprise interface and records a SC with electronic financial account identifier in a SC database. Once the execution commitment is received, the decentralized controller executes the step of determining whether the execution commitment meets or exceeds the minimum reward. The decentralized controller also executes the steps of validating the smart contract and validating the at least one execution commitment. The decentralized controller is further responsible for delivering the at least one execution commitment to the consumer interface upon receiving the at least one execution commitment from the enterprise, receiving additional transaction details from the consumer interface; and generating, electronically, a counteroffer and delivering the counteroffer to the enterprise interface. All transactions are tracked throughout the process. For instance, the decentralized controller may perform the steps of adding a tracking number and time stamp to one of the smart contract or the at least one execution commitment.

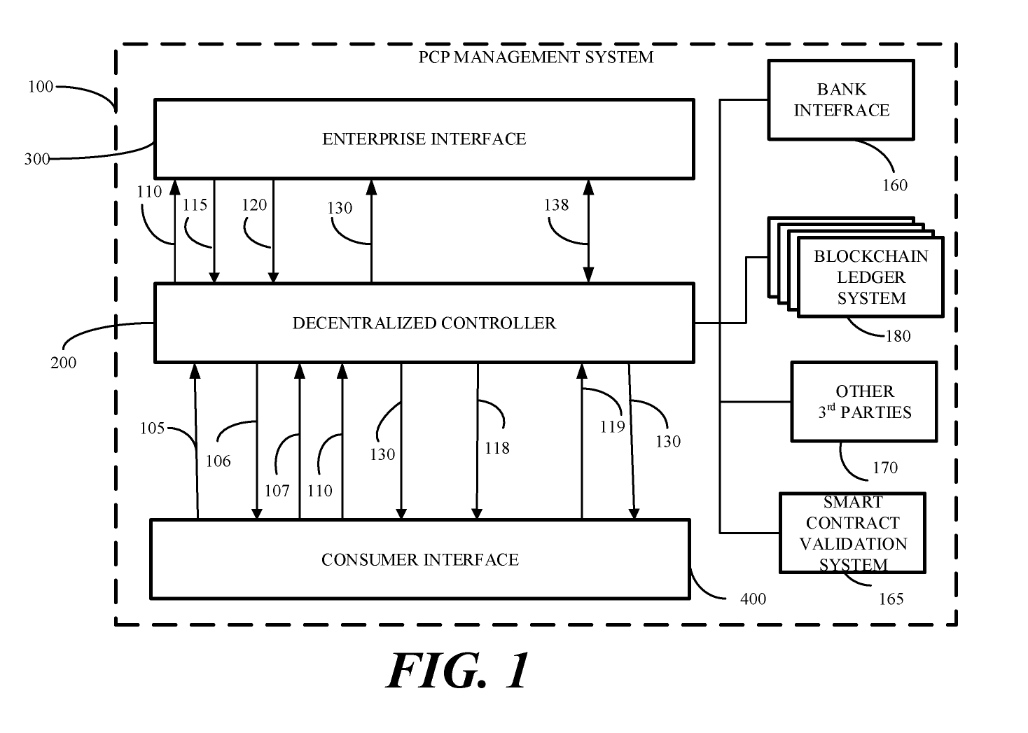

Turning first to FIG. 1, illustrated therein is one embodiment of an electronic system 100 far decentralized permission, consent and preference management to securely stare consumer private data and provide restricted access to it, represented by SCs, between consumer and at least one of a plurality of enterprises. The system 100 will be referred to herein as a “PCP Management System” (PCPMS) system for discussion purposes. In one embodiment, the PCPMS includes a decentralized controller 200, an enterprise interface 300 and a consumer interface 400.

The system 100 receives private data 105 from consumer and provides the consumer with reward offers 106 to choose from if any available. The system 100 allows consumer to commit to SCs. Thus, an enterprise is able to communicate their initial offer for a specific reward to a consumer. Such an offer provides the consumer with the confidence that if he will commit to offer, he will benefit from the corresponding financial rewards when smart contract SC based on the offer is executed. Once SC 110 has been accepted by enterprises, the system 100 allows enterprise to engage consumers. The consumer engagement CE 119 may be by consumer via consumer interface 400.

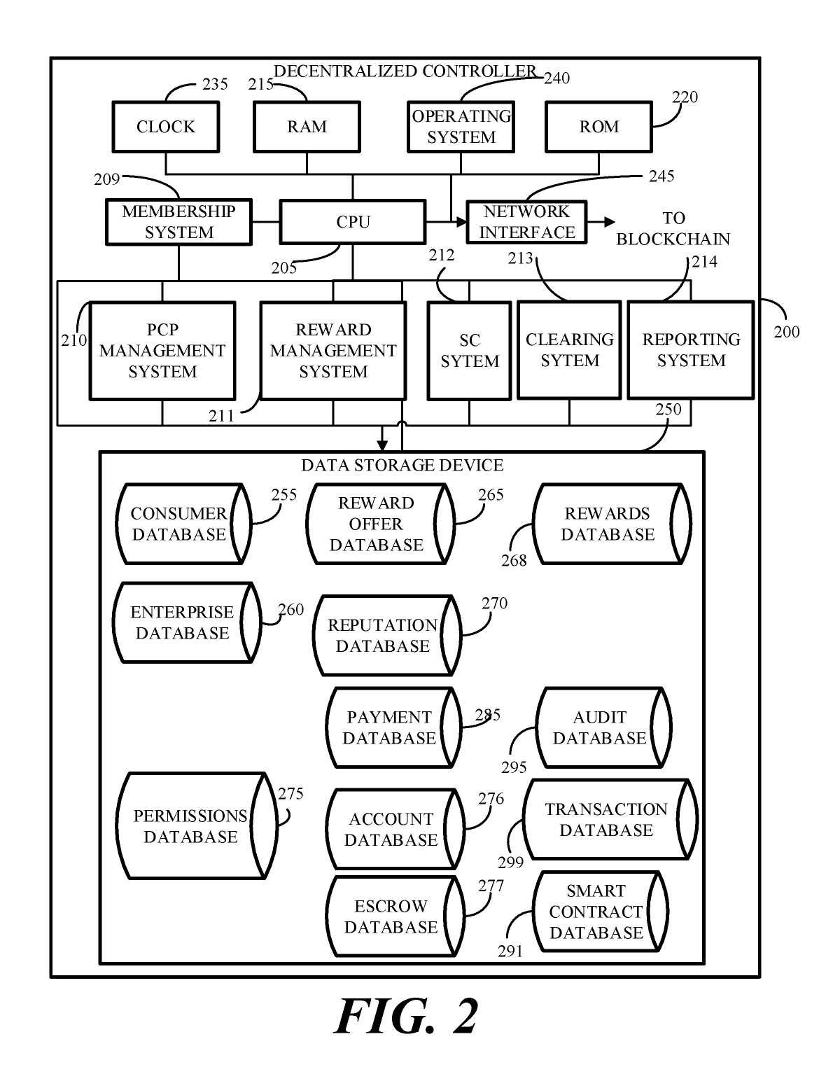

FIGS. 1 through 4 illustrate one preferred architecture for a system 100 in accordance with the invention. As shown FIG. 1, the system 100 includes a decentralized controller 200, an enterprise interface 300, a consumer interface 400, a Blockchain ledger system 180, a bank interface 160, a smart contract validation system 165 and a connection to various other third parties 170. Each of these connections is referred to as a “node.”

Each node is connected to another via a network connection, such as an Internet connection. The connection may be accomplished using a public switched telephone or broadband network, such as those provided by a local or regional telephone operating company. Communication connections may also be provided by dedicated data lines, cellular, Personal Communication Systems (“PCS”), microwave, or satellite networks. The nodes serve as the input and output gateways for communications with decentralized controller 200.

Turning now to HO. 2, the decentralized controller 200 includes central processor (CPU) 205, RAM 215, ROM 220, the membership system 209, the preferences, consent and permission (PCP) management system 210, the reward management system 211, the smart contract (SC) system 212, the clearing system 213, the reporting system 214, and other components, such as a clock 235, an operating system 240, a network interface 245, and a data storage device 250. Each of the systems may comprise executable software, functional with the CPU, and stored in memory. A conventional server computer with sufficient memory and processing capability may be used as decentralized controller 200. In one embodiment the decentralized controller 200 operates as a web server, both receiving and transmitting SCs 110 generated by consumers The decentralized controller 200 may also receive and transmit consumer engagements CEs 119.

In one embodiment, the decentralized controller 200 is configured to handle a high volume of transaction processing. The decentralized controller 200 also performs a significant number of mathematical calculations in processing communications and database searches. One example of a processor suitable for use as the CPU 205 is Intel® Xeon Processor E7-4820 v4, commonly manufactured by Intel Inc. Equivalent processors include AMD Opteron 6300 Series Processors commonly manufactured by AMD.

While the various systems may comprise executable software, each may elude its own processor as well. For instance, the membership system 209, PCP management system 210, reward management system 211, SC system 212, the clearing system 213 and reporting system 214 may each have their own dedicated microprocessor (such as the Intel Xeon). Alternatively, these systems may be configured as part of the central CPU 205.

The membership system 209 authenticates the identity of enterprises and consumers. It uses an enterprise database 260 and a consumer database 255 to match identities of users that communicate with decentralized controller 200. The PCP management system 210 keeps the list of preferences, consent and permissions that consumers specified. The reward management system 211 manage rewards submitted by enterprises and stores it in the reward offer database 265. The SC system 212 processes consumer and enterprise quests for executing smart contract. Enterprises provide PCP query 115 and receive one or more interested consumers meeting their query criteria in return.

The SC system 212 facilitates creation of the smart contract (SC). The SC system 212 further processes the commitment to SCs 110, and execution commitments 120. This system provides all necessary operators reward offer issue by enterprise. The reward management system 211 delivers all consumer selected engagements. The SC system records consumer's engagement (CE) 119.

The clearing system 213 processes all engagements which have a “pending” status. This system communicates with the Blockchain ledger 180 and other 3^{rd} parties 170 to complete recording of transaction and reward processing if needed. The reporting system 214 keeps track of every transaction by decentralized controller 200, thus maintains a history of every interaction and transaction. This system also provides reports to enterprises and consumers on all of their activities and monitors for various compliance issues.

The data storage device 250, which may include hard disk, magnetic disk, optical storage units, CD-ROM drives, or flash memory, contains databases used in the processing of transactions These databases include the reward offer database 265, the rewards database 268, the smart contract database 291, the consumer database 255, the permissions database 275, the account database 276, the reputation database 270, the payment database 285, the escrow database 277, the transaction database 299, and the audit database 295. In a preferred embodiment database software such as Microsoft SQL Server 2014, manufactured by Microsoft Corporation, is used to create and manage these databases.

The consumer database 255 maintains data on consumers with fields such as unique identifier, name, address, phone number, ID number, electronic mail address, past system usage, etc. This information is obtained when the consumer first registers with the system, or immediately prior to setting up his or her preferences, consent and permissions PCP 105.

The account database 276 tracks all information pertaining to the consumer's account with fields such as consumer's name, bank account numbers, a Blockchain ledger address, and debit or credit transactions. Enterprise rewards for SCs 110 may be sent to this database. This database may be a pointer to account data stared at the Blockchain ledger.

The enterprise database 260 maintains data on enterprises with fields such as unique identifier, name, contact information, topic of preferences. Contact information comprises a phone number, web page URL, blog address, pager number, telephone number, electronic mail address, voice mail address, facsimile number, or other contact indicia. Upon registration, the enterprise may be required to demonstrate evidence of a consumer's activity with ability to engage with SCs 110 or CEs 119.

The account database 276 tracks all information pertaining to the enterprises account with fields such as enterprise's name, unique identified, bank and credit account numbers. This database may be a pointer to account data stored at the Blockchain ledger.

The permission database 275 tracks all consumer's preferences, consent and permissions in connection to an enterprise with fields such as consumer's id, list of preferences, list of permissions, timeframe for enterprise access, enterprise id.

The reward offer database 265 tracks all reward offers 106 with fields such as status, tracking number, date, time, reward, expiration date, conditions, and enterprise identification number. This database is valuable in the event of disputes between consumers and enterprises regarding payment, because details of the reward offer can be produced.

The reputation database tracks all feedback received by enterprises and consumers. It used to store and track the quality of engagement with a reward offer and the quality of enterprise and consumer engagements.

The rewards database 268 tracks all enterprise rewards via transaction o firma s 130 and all consumer rewards via transaction confirmations 130. The structure of this database has a field for a SC tracking number to facilitate enterprise rewards, via transaction confirmations 130 and consumer rewards via transaction configurations 130 being correlated with a particular SC 110. This database may be a pointer to data stored at the Blockchain ledger.

The smart contract database 291 connects SCs 110 and enterprise with unique enterprise ids. The structure of this database specifies the generic contract details common to most SCs 110 and fills in the details of conditions specified by the enterprise and the corresponding SC 110. This database may be a pointer to data stored at the Blockchain ledger.

The payment database 285 tracks all payments made by the system with fields such as member's unique identifier, amount of payment, associated SC 110 and CE 119 tracking number. This database may also store bank account information of members or public Blockchain ledger address.

The escrow database 277 temporary holds funds before they are placed in the corresponding account of the account database 276. These funds may also be transferred from the escrow account database 277 to the account database 276.

The audit database 295 stores transactional information relating to the posting of SCs 110, CEs 119, and any other transaction processed by the decentralized controller 200 This database allows such data to be retrieved for later analysis.

The transaction database 299 holds transactional information relating to transactions handled by the decentralized controller 200. This database may be a pointer to data stored at the Blockchain ledger.

The network interface 245 is the gateway to communicate with enterprises and consumers, the Blockchain ledger 180 and third parties 170 or third party systems such as the bank interface 160 and smart contract validation system 165. Conventional internal or external modems, or network cards, may serve as the network interface 245. In one embodiment, the network interface 245 supports modems at a range of baud rates from 1200 upward, but may combine such inputs into a T1 or T3 line if more bandwidth is required. In one preferred embodiment, the network interface 245 is connected with the Internet and/or any of the commercial on-line services such as DSL or Cable Internet, thereby allowing enterprises and consumers to access the system 100 from a wide range of on-line connections. The system 100, in one embodiment, is platform independent and utilizes open standards based on commonly understood Internet protocols. The system 100 also supports multiple languages. The system 100 may alternatively be configured as a voice mail interface, web site, bulletin board, or electronic mail address.

While the paragraphs above describe generally a single computer acting as decentralized controller 200, it will be obvious to those of ordinary skill in the art having the benefit of this disclosure that system functionality can be distributed across a plurality of computers. In one embodiment, the decentralized controller 200 is configured in a distributed architecture, where the databases and corresponding processors are housed in separate units or locations. Some controllers perform the primary processing functions and contain at a minimum RAM, ROM, and a general processor. Each of these controllers is attached to a WAN hub which serves as the primary communication link with the other controllers and interface devices. The WAN hub may have minimal processing capability itself, serving primarily as a communications router. Those skilled in the art having the benefit of this disclosure will appreciate that an almost unlimited number of controllers may be supported. This arrangement can yield a dynamic and flexible system, which may be less prone to multiple processor hardware failures.

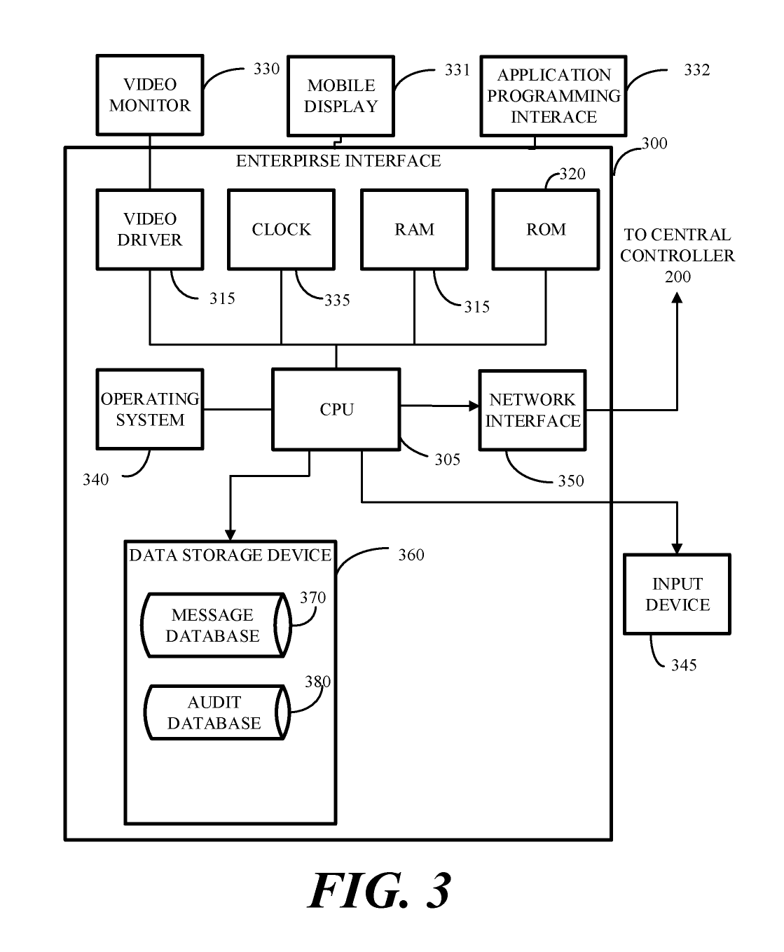

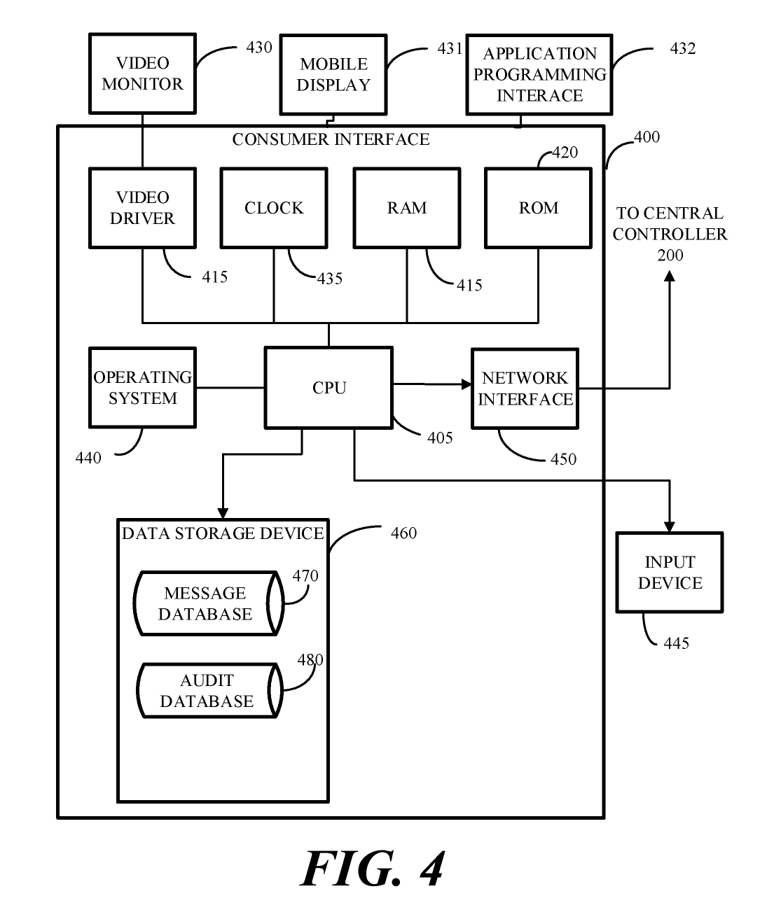

Turning now to FIGS. 3 and 4, illustrated therein are the enterprise interface 300, and consumer interface 400 respectively. In an exemplary embodiment, the enterprise interface 300 and the consumer interface 400 comprise conventional personal computers having an input device, such as a keyboard, mouse, or conventional voice recognition software package; a display device, as a video monitor, a processing device such as a CPU; and a network interface such as a modem or network card or personal mobile device such as a smartphone. These devices interface with decentralized controller 200 across a network. Alternatively, enterprise interface 300 and consumer interface 400 may comprise other devices, such as voice mail systems, fax machines, pagers, PDAs, mobile phones, or other electronic or voice communications systems.

Referring now to FIG. 3, the enterprise interface 300 includes a central processor (CPU) 305, RAM 315, ROM 320, a clock 335, a video driver 325, a video monitor 330 or mobile display 331, an application programming interface (API) 332, an operating system 340, an input device 345, a network interface 350, and a data storage device 360. A Xeon microprocessor such as the Intel Core 2 Duo E6700 described above may be used for CPU 305 or Qualcomm Snapdragon 835 mobile platform. The clock 335, in one embodiment, is a standard chip based clock which can serve to timestamp a SC 110, a CE 119.

The data storage device 360 is a conventional magnetic-based hard disk storage unit such as those manufactured by Maxtor or memory storage card such as those manufactured by Samsung. The message database 370 may be used for archiving SCs 110 and CEs 119, while the audit database 380 may be used for recording payment records and communications with decentralized controller 200.

Referring now to FIG. 4, the consumer interface 400 includes a central processor (CPU) 405, RAM 415, ROM 420, a clock 435, a video driver 425, a video monitor 430 or mobile display 431, an application programming interface (API) 432, an operating system 440, an input device 445, a network interface 450, and a data storage device 460. All of these components may be identical to those described above in reference to FIG. 3.

Communications between the nodes and the decentralized controller 200 may be enabled by various commercial software applications available today. Microsoft Outlook, manufactured by Microsoft Corporation, for example, provides editing tools for the creation of messages as well as the communications tools to route the message to the appropriate electronic address. When the decentralized controller 200 is configured as a web server, conventional communications software such as the Internet Explorer web browser from Microsoft Corporation may also be used. The enterprise interface 300 and consumer interface 400 may use the Internet Explorer browser to transmit SC 110, enterprise execution commitments 120, consumer engagement CE 119 or transaction confirmations 130.

In one embodiment of the invention, transactions between consumers and enterprises take place across a network, with the decentralized controller 200 acting as a web server. The consumer logs on to the decentralized controller 200 and stores PCP with a smart contract as described above. The consumer then disconnects from the network. The decentralized controller 200 makes the smart contract available to enterprise by posting it on, for example, the web page of the decentralized controller 200. The decentralized controller 200 also performs periodic to ensure that active smart contracts have not expired.

Enterprises transmit smart contract execution commitments 120 electronically to the decentralized controller 200, which in turn saves them in the smart contract database 291. Once an enterprise smart contract execution commitment 120 for a given SC have been validated, i.e. financially meets the reward requested by the SC, the decentralized controller 200 marks the SC 110 active.

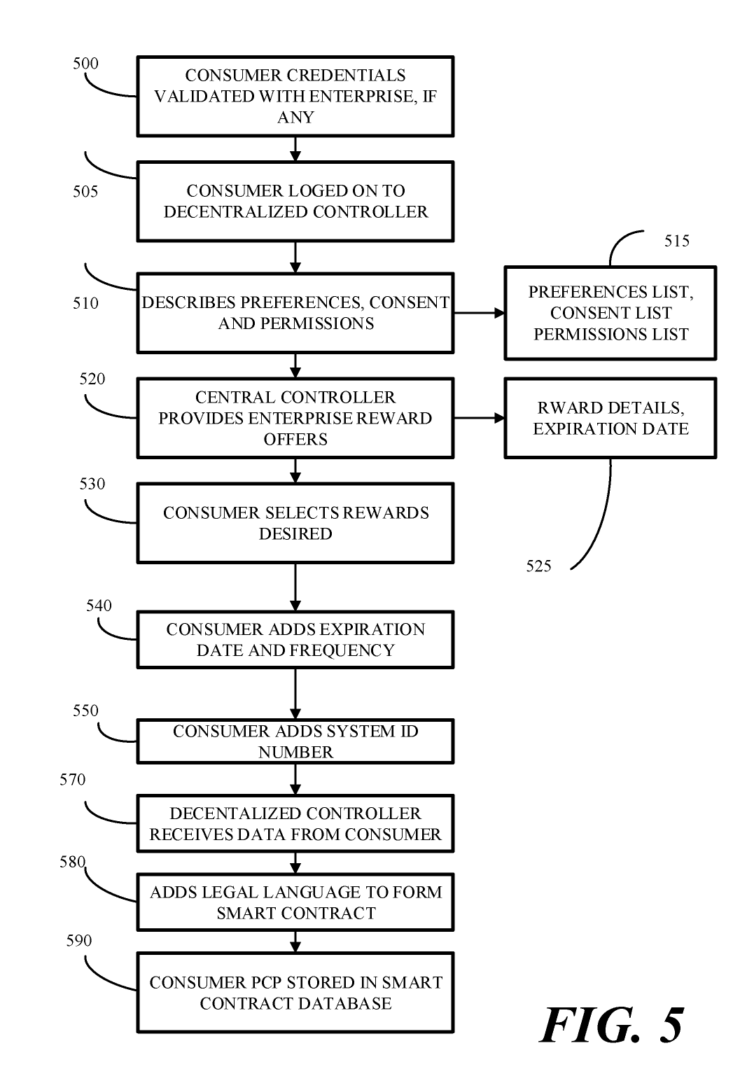

Turning now to FIG. 5, illustrated therein is one embodiment of a method by which the consumer and the enterprise formulates a SC. At step 500, the consumer credentials are validated with enterprise. If the enterprise does not require consumer credentials validation, the validation is performed in the next steps by decentralized controller. The consumer logs on to the decentralized controller 200 by way of the consumer interface 400, thereby establishing a communication link. In one embodiment, the decentralized controller 200 provides a page on the World Wide Web, thereby allowing the consumer to communicate with the decentralized controller 200 through the interface of conventional web browser software such as Internet Explorer, manufactured by Microsoft Corporation, in another embodiment, the consumer interface 400 is a mobile application running on a mobile device like a smart phone, communicating with decentralized controller 200 via the Internet, and in another embodiment, the consumer e face 400 is an application programming interface (API) provided by the decentralized controller 200 through the interface of conventional web service software such as Internet Information Service (IIS) manufactured by Microsoft Corporation.

At step 510, the consumer provides the preference, consent and permission information for the enterprise upon which be wants to create SC, As shown in box. 515, information might include the consumer preference list, the consent list based on the enterprise requirements, the permission list granting the enterprise various permissions, etc. After the information is provided, a form is displayed on vide© monitor 430 or mobile display 431 of consumer interface 400.

At step 520, the consumer receives a list of rewards from enterprise available to him if any. These options are prepared by the reward management system 211 of the decentralized controller 200. As shown in the box 525, reward offer options might include enterprise name, reward details, expiration date. An enterprise, for example, might want to reward consumer for watching sponsored videos from 3^{rd} party advertisers. An advertiser wants to reach consumers who are interested in new fashion, and have explicitly consent to advertisement with the enterprise. The enterprise is the online blog about new fashion trends. In accordance with one embodiment, the enterprise would upload reward offer, select reward structure, total budget, etc. The enterprise simply fills in the blanks. The consumer then reviews choices for choice of rewards 520 and chooses the one or more that mast closely meets his needs. These choices would be selected and the corresponding SC generated.

Reward offer term and conditions may be modified so as to allow the consumer to tailor SC for his specific needs. The SC may also be based on one or more enterprise conditions. For example, one condition might state that consumers receive a specific reward that the enterprise confirms. Conditions may be based on external events. For example, the consumer may want to share the reward with his or her social network, in exchange, the enterprise would share with the consumer 20% of that reward. SC system 212 keeps all of those conditions in the smart contract database 291.

The consumer selects reward choices at step 530. At the step 540 the consumer may add an expiration date and access frequency to the SC if desired. This expiration date option allows the consumer to agree to a SC without worrying about being bound after a date certain, for example when his interests or needs may have changed. The frequency option allows the consumer to limit the number of times the enterprise would engage in promotional advertisement to the consumer.

At step 550, the consumer attaches his name or a unique system identification number to the SC. The decentralized controller 200 provides the identification number when the consumer registers for the service. Alternatively, the consumer chooses the unique identification number and then registers with decentralized controller 200 by phone. The decentralized controller 200 maintains a list f the unique identification numbers in the consumer database 255. Where less security is required, the consumer's Blockchain ledger address could serve as the unique identification number, as, it offer the advantages of being both unique and easily accessible,

The consumer then transmits the information to the decentralized controller 200 at step 570. At step 580, boilerplate language is added to the SC to complete the SC. The boilerplate language is stored in the smart contract database 291.

As an alternative to the network interface, the consumer may also transmit SC data via electronic mail, voice mail, facsimile, or postal mail transmissions With voice mail, the consumer calls the decentralized controller 200 and leaves SC data in aural form. The SC information may be transcribed into digital text at the decentralized controller 200, or may alternatively be made available to the enterprise in the aural format. In a mail enabled embodiment, the decentralized controller 200 acts more like a router, directing SCs to the enterprise. The SCs may also be posted to bulletin boards, web pages or accessible via application program interface (API) operated by the decentralized controller 200.

As noted, the decentralized controller 200 supports a plurality of transmission methods, allowing far a wide variety of formats of SCs. Some formats may be changed, however, before further processing by the decentralized controller 200. By way of example, the SCs may be transmitted by mail in paper form, may be scanned and digitized using optical character recognition software to create digital text. These embodiments are more fully described in the off-line embodiment described later.

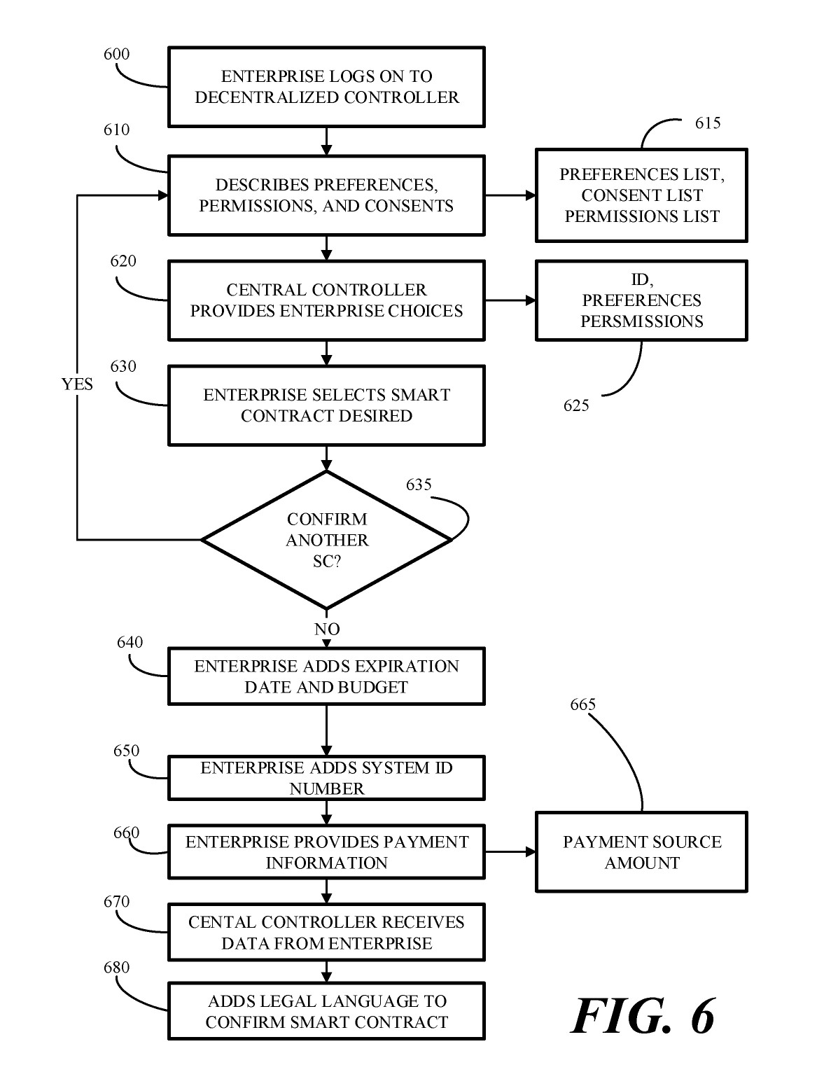

Turning now to FIG. 6, illustrated therein is one embodiment of a method by which the enterprise commits to a SC. At step 600, the enterprise logs on to the decentralized controller 200 by way of the enterprise interface 300, thereby establishing a communication link. It should be noted that the enterprise may be an individual, a corporation, a partnership, a government, or any other entity. In one embodiment, the decentralized controller 200 provides a page on the World Wide Web, thereby allowing the enterprise to communicate with the decentralized controller 200 through the interface of conventional web browser software such as Internet Explorer, manufactured by Microsoft Corporation, in another embodiment, the enterprise interface 300 is a mobile application running on a mobile device like a smart phone, communicating with decentralized controller 200 via the Internet and in another embodiment, the enterprise interface 300 is an application programming interface (API) provided by the decentralized controller 200 through the interface of conventional web service software such as Internet Information Service (IIS) manufactured by Microsoft Corporation.

At step 610, the enterprise provides the PCP information for the consumers upon which he wants to commit to SC. As shown in box 615, information might include permissions list, preferences list, consents, the rewards paid for engagement, etc. After the information is provided, a form is displayed on video monitor 330, mobile display 331 or application programming interface API 332 of enterprise interface 300.

At step 620, the enterprise receives a list of smart contracts available to him. These options are prepared by the SC system 212 of the decentralized controller 200. As shown in the box 625, smart contracts might include consumer id, consumer preferences, consumer permissions and so forth. An enterprise, for example, might have an advertiser that wants to advertise its new collection for the fall. An advertiser s to reach consumers who are interested in new fashion, and would want an enterprise to use a SC to target those members. In accordance with one embodiment, the enterprise would upload advertising offer, commit to reward structure, total budget, etc. The enterprise simply fills in the blanks. The enterprise then reviews choices for list of smart contracts 620 and chooses the one or more that most closely meets his needs. These choices would be selected and the corresponding SC confirmed.

Smart contract term and conditions may be modified so as to allow the advertiser to tailor SC for his specific needs. The SC may also be based on one or more consumer conditions. For example, one condition might state that consumer receive $1 as the reward for engagement. Conditions may be based on external events. For example, the consumer may want to share the engagement with his or her social network, in exchange, the enterprise would reward with the consumer $1 for his effort. SC system 212 keeps all of those conditions in the smart contract database 291.

The enterprise selects SC choices at step 630. At the step 635, if the enterprise wants to commit to another SC, he repeats the process starting at the step 610. If not, a next step is 640, where the enterprise may add an expiration date and budget to the SC if desired. This expiration date option allows the enterprise to post a SC without worrying about being bound after a date certain, for example when his needs may have changed. The budget option allows the enterprise to limit the reward payment to the specific amount per consumer and for all consumers.

At step 650, the enterprise attaches his name or a unique system identification number to the SC. The decentralized controller 200 provides the identification number when the enterprise registers for the service. Alternatively, the enterprise chooses the unique identification number and then registers with decentralized controller 200 by phone. The decentralized controller 200 maintains a list of the unique identification numbers in the enterprise database 260. Where less security is required, the enterprise's Blockchain ledger address could serve as the unique identification number, as it offer the advantages of being both unique and easily accessible.

At step 660, the decentralized controller 200 may ask the enterprise to provide additional payment information. As indicated in box 665, the payment information may include the enterprise's full name, payment source, bank account information, credit card, permission to use virtual coins, and so forth.

The enterprise then transmits the information to the decentralized controller 200 at step 670. At step 680, boilerplate language is added to the SC to complete the SC. The boilerplate language is stored in the smart contract database 291.

As an alternative to the network interface, the enterprise may also transmit SC data via electronic mail, voice mail, facsimile, or postal mail transmissions. With voice mail, the enterprise calls the decentralized controller 200 and leaves SC data in aural form. The SC information may be transcribed into digital text at the decentralized controller 200, or may alternatively be made available to potential consumers in the aural format. In a mail enabled embodiment, the decentralized controller 200 acts mare like a router, directing SCs to the potential consumers, and creating multiple copies of SCs when necessary. The SCs may also be posted to bulletin boards or web pages operated by the decentralized controller 200.

As noted, the decentralized controller 200 supports a plurality of transmission methods, allowing for a wide variety of formats of SCs. Some formats may be changed, however, before further processing by the decentralized controller 200. By way of example, the SCs may be transmitted by mail in paper form, may be scanned and digitized using optical character recognition software to create digital text. These embodiments are more fully described in the off-line embodiment described later.

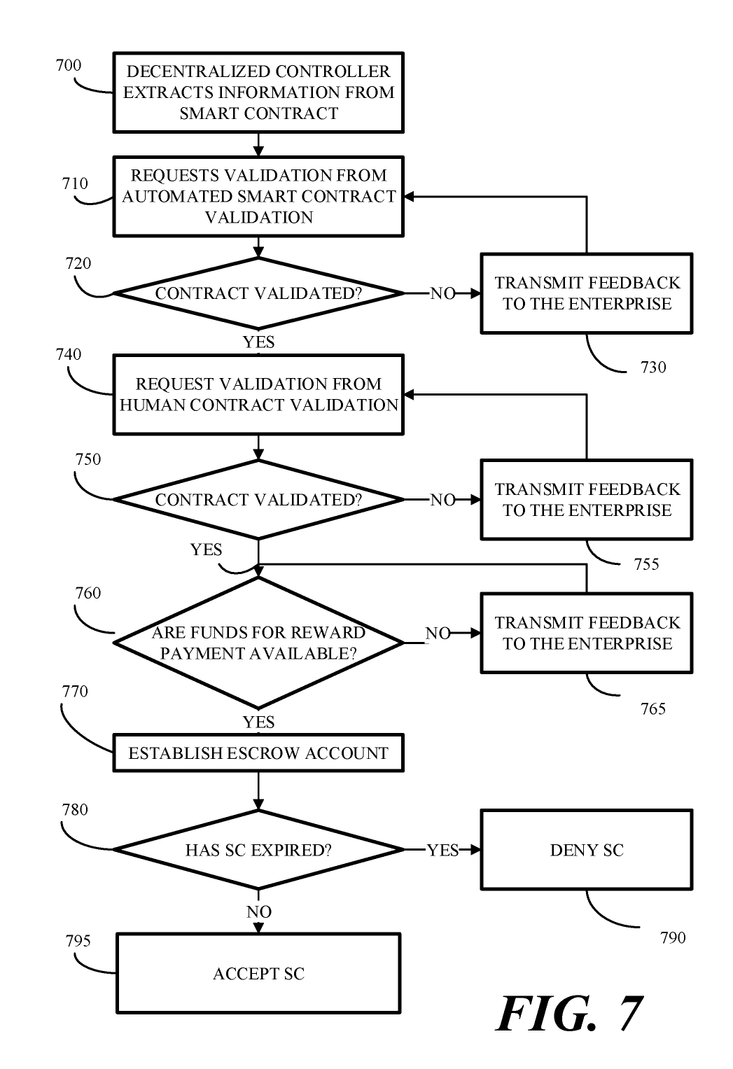

Referring now to FIG. 7, illustrated therein is a method of processing a SC in the decentralized controller 200 once the enterprise has transmitted the SC. When the SC is received, the decentralized controller 200 validates all information entered by the enterprise to ensure that the smart contract does not violate any policies, monetary amounts are available and all conditions are justified. This occurs before the decentralized controller 200 makes the SC confirmed.

At step 700, the decentralized controller 200 extracts information from the SC. At step 710, decentralized controller 200 submits smart contract for validation to the smart contract validation system 165. One function of this submission is to validate the smart contract against contract policies set forth by decentralized controller and consumers, as an example “hate speech” is not acceptable content by decentralized controller. The decentralized controller 200 essentially checks to see if there is a violation of policies in SC.

At step 720, the smart contract validation system 165 responds to the contact validation, indicating whether the contact meets all of the policies. If there is cause to believe that the offer is not validated, feedback supporting this cause is transmitted to enterprise at step 730.

The enterprise then has the opportunity to update the smart contract or provide support for the original contract. Where the SC information is updated or support is transmitted, decentralized controller 200 then resubmits the request for data validation at step 710. At step 740, the decentralized controller 200 requests the other 3^{rd} parties validation 170, like human smart contract validation to validate enterprise contract information which may be extracted from the SC. At the step 750, if the contract validation fails in the SC, an indication of the violation is transmitted to enterprise at step 755. As before, the enterprise has the opportunity to correct and update smart contract or provide support for the original contract. Once the enterprise has updated smart contract, decentralized controller 200 then resubmits the request for data validation to the human contract validation as the 3^{rd} party 170 at step 740.

At the step 760, the decentralized controller 200 validates if funds for reward payment is available. If funds are available to cover the required amounts, the decentralized controller 200 establishes escrow account in the step 770. If the funds are not available as required in the SC, an indication of the amount shortage is transmitted to enterprise at step 765. The enterprise has the opportunity to correct or validate the information or alternatively to deposit h or virtual coin in the amount required to establish escrow account Once the enterprise has established required escrow account, decentralized controller 200 then resubmits the request for funds validation at step 760.

With the validation/correction processes transpiring, the decentralized controller 200 may check the SC to see if it has expired at step 780. If expired, the SC is rejected at step 790 and returned to the enterprise. If the SC has not yet expired, it is accepted at step 795.

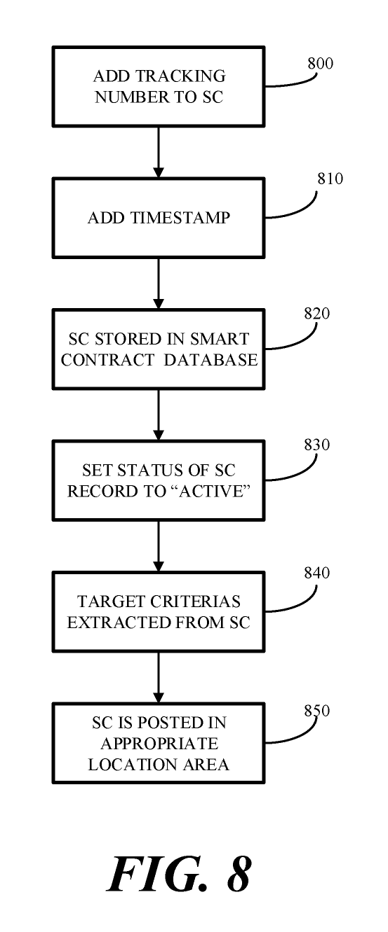

Referring now to FIG. 8, there is illustrated one method of activating and making public a SC in accordance with embodiments of the invention. Specifically, the decentralized controller 200 activates the SC and makes it available to the enterprise via the SC system 212.

At step 800, a unique tracking number is added to the SC. Additionally, the SC system 212 timestamps the SC at step 810 and stores the SC in the smart contract database 291. The smart contract database 291, in one embodiment, contains a record for each SC and includes fields such as status, tracking number, timestamp, reward, expiration date, conditions, and enterprise ID number.

The status field, in one embodiment, has values of “pending,” “active,” “expired,” and “completed.” A status of “pending” means that the SC is not currently available to the enterprise. This may be the case because the SC is either still being processed by decentralized controller 200, or perhaps the enterprise or consumer has temporarily suspended the SC.

An “active” SC becomes available to enterprise and can be executed. An “expired” SC can no longer be executed. Once the entire SC has beets fulfilled by the enterprise and consumer, the SC is given a status of “completed.”

After being stored at step 820, the SC may go through a series of processing steps. One step, if necessary, is language translation. Language translation may include either creating aa equivalent SC in a standard language for the system, or translating the SC to a common language that is viewable by the enterprise. Language experts at decentralized controller 200 provide the translation. Alternatively, automatic translation software such as Systran Professional, manufactured by Systran Software, may be used. Many bi-directional language combinations are available, including English to/from French, Italian, German, Spanish, Portuguese, and Japanese. Another step, if necessary, is to edit for typographical and other errors. The decentralized controller 200 may also again verify the information in the SC with various third party systems 170 and reward validation system 165.

At step 830 the status of the database record for the SC is set to “active.” At step 840, the target criteria extracted of the SC is extracted from the target interest field. At step 850, the SC is posted in an appropriate location area. This allows, in one embodiment, the SC system 212 to display the SC only to the enterprise specific criteria. In a World Wide Web environment, the SC system 212 has a web page for each target interest area. In mobile device environment, the SC system 212 has a filter for each target interest area. In application programing interface, the SC system 212 has a programming access for each target interest area. Thus, all SCs with preferences for a new fashion, for instance, would be displayed on the new fashion web page. This presentation makes it much easier for enterprise to find appropriate SCs, as they can go right to the target interest.

In one embodiment, the SC is automatically matched to enterprise needs based on the specified target interest by the SC system 212. In that case the enterprise specifically requests to execute the SC to its consumers with reward offer 106.

In an alternative embodiment, the SC is electronically mailed to the enterprise. The enterprise may optionally elect to receive all SCs, only those SCs in the specific target interest, or a subset of SCs representing a particular enterprise specified condition. For example, the enterprise might request that all SCs with the interest for new fashion he sent to them,

In embodiments where SCs are being transmitted to the enterprise, it is important to note that there am a number of hardware options for enterprise interface 300, some of which have been noted above in the description of FIG. 3. Suitable enterprise interfaces 300 include fax machines, PDAs with wireless connections, beepers, or pagers. For example, the enterprise in England may instruct the decentralized controller 200 to “beep” him whenever a SC appears for a travel interest to United States. The enterprise may request that the decentralized controller 200 provide details of the SC over the beeper network. Alternatively, the enterprise may request that the decentralized controller 200 inform the enterprise to log on to the decentralized controller 200 for further details.

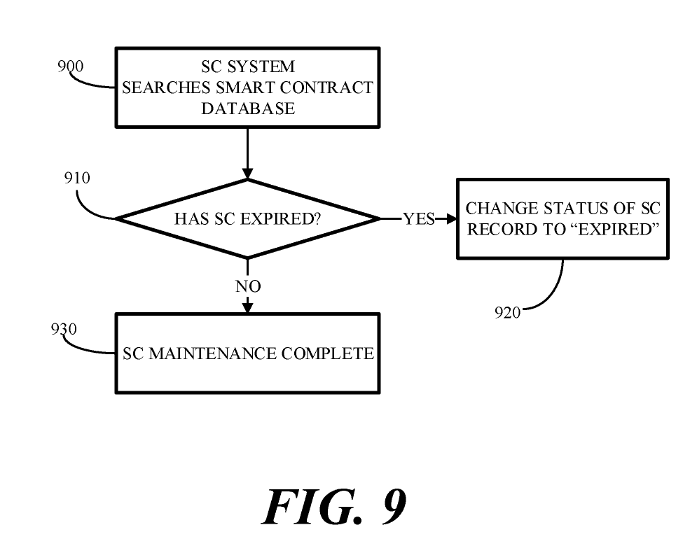

Turning now to FIG. 9, illustrated therein is one procedure for SC maintenance in accordance with embodiments of the invention. At step 900, the SC system 212 searches the smart contract database 291. At step 910, the expiration date field of each database record is compared to the current date. If the expiration date of the SC is earlier than the current date, the status of the SC is changed to “expired” or at step 920. The maintenance process is completed at step 930 once all “active” SC database records have been examined.

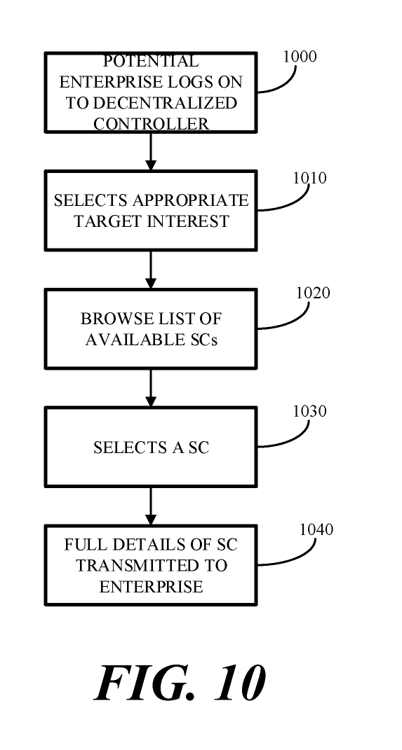

Turning now to FIG. 10, illustrated therein is one embodiment of a method by which a potential enterprise selects a SC in accordance with the invention. At step 1000, the potential enterprise logs auto the decentralized controller 200 using the network interface 350 of the enterprise interface 300. At step 1010, the potential enterprise selects an appropriate target interest. For example, the enterprise has an advertiser for new gadget, may select the electronics interest since enterprise website is all about new gadgets. As such, the enterprise y search the electronics interest in hope of finding an appropriate SC.

At step 1020, the potential enterprise browses the list of available SCs (i.e. those with a status of “active”). The SCs, in one embodiment, are listed with minimal details. Additional information is available where selected by the enterprise or where the potential enterprise is interested in executing a particular SC. Continuing with the electronics SC example from the preceding paragraph, a corresponding SC might be listed as “0ABDC—electronics—$1—3month”,

At step 1030 the potential enterprise selects a specific SC. The potential enterprise may request additional data at step 1040. In one embodiment, each SC is hyperlinked to a separate web page, in case of the mobile device it opens a separate display window or in case of the application programming interface (API) it returns additional data in JSON or XML format. That web page, display window or API results may provide complete details or information. Upon accessing the web page, display window or API results, the potential enterprise may select on the SC and be immediately transferred to a page or pages of supporting detail. This supporting detail may include a past history of engagements, detailed target interest information, and so forth. In an alternate embodiment, the SC is electronically transmitted directly to the enterprise. Transmission methods include application programming interface (API), electronic mail, fax, telephone, beeper, or other communication means.

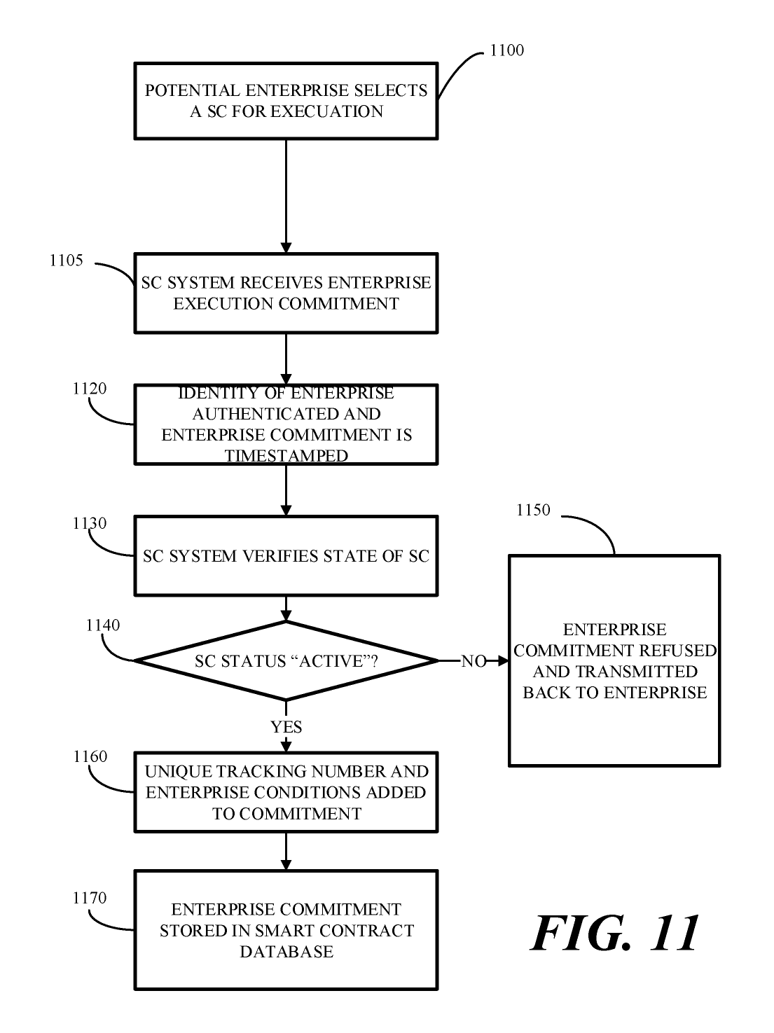

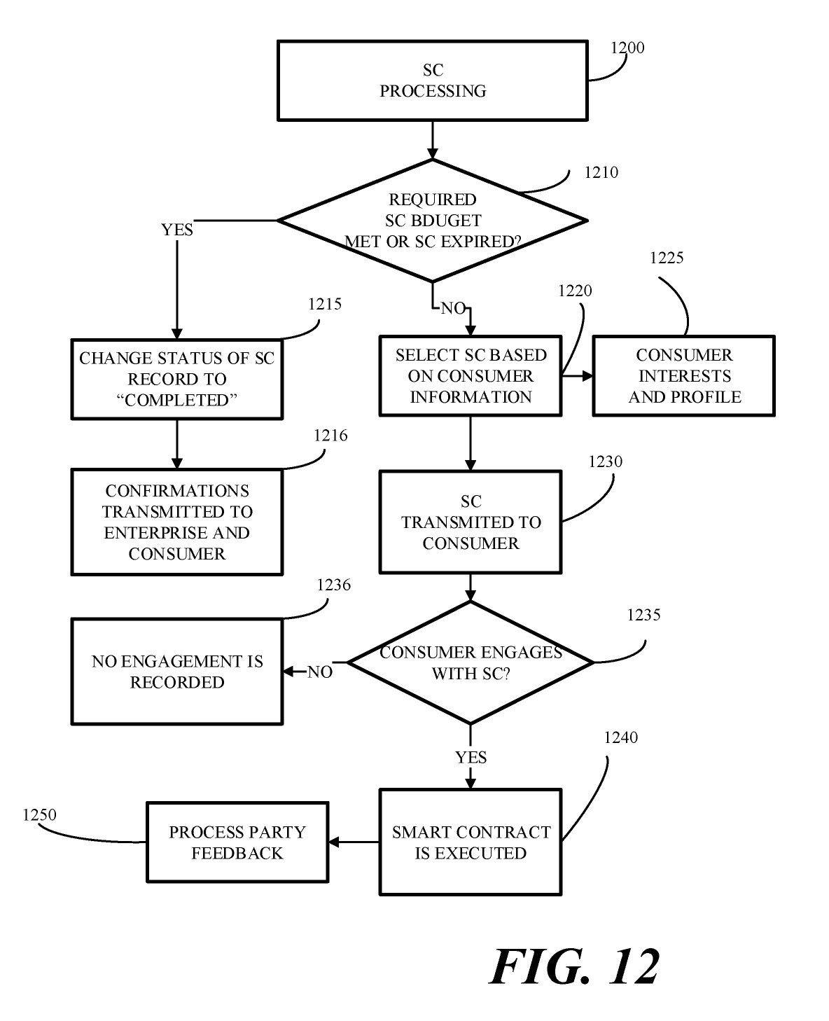

Turning now to FIGS. 11 and 12, illustrated therein is one method by which an enterprise participates in SC in accordance with embodiments of the invention. At step 1100, the potential enterprise selects the SC for execution commitment. At step 1105, the SC system 212 receives the enterprise execution commitment 120 from the potential enterprise. The SC system 212 then timestamps enterprise execution commitment 120 and authenticates the identity of the enterprise using membership system 209 at step 1120. The timestamp allows the SC system 212 to determine the order iii which enterprise execution commitments 120 are to be processed. Alternatively, the timestamp may be appended to the enterprise execution commitment 120 at the time it is transmitted from enterprise interface 300, using the clock 335 of the enterprise interface 300.

Authentication cute ty involves the decentralized controller 200 extracting the unique system ID from enterprise execution commitment 120 and looking up the enterprise's identity in the enterprise database 260. Information in the enterprise database 260 then provides an indication of the enterprisers ability to access the required consumers with target interest in case of execution commitment 120. In another embodiment, the enterprise incorporates the enterprise execution commitment 120 into the SC. The enterprise may further sign the SC by adding an electronic signature or other indication. This indication could be a digital signature, or could involve adding a symbol or indicia representative of the enterprise.

The SC system 212 then verifies the status of SC at step 1130, determining whether or not the status of the SC is “active” at step 1140. If the SC is currently “active,” a unique tracking number is added to the enterprise execution commitment 120 at step 1160. The SC system 212 then stores enterprise execution commitment 120 in the smart contract database 291 at step 1170. If the status of SC is not “active” at step 1140, the decentralized controller 200 refuses the enterprise execution commitment 120 and transmits the enterprise execution commitment 120 back to the potential enterprise at step 1150.

Turning now to FIG. 12, illustrated therein is one embodiment of a SC execution process in accordance with embodiments of the invention. The SC execution process begins at SC processing step 1200. The decentralized controller 200 checks the validity of the SC at step 1210, The decentralized controller 200 completes SC when enterprise budget is exhausted or where the SC reached the expiration date. The decentralized controller 200 may additionally continue SC where the enterprise budget has not been set or there is no expiation date in such a case, the SC may retain its status of “active” until an enterprise pauses or cancel SC.

At step 1215, SC system 212 changes the status of SC record to “completed”. The smart contract database 291 is updated and the transaction confirmation 130 transmitted to both consumer and enterprise in the step 1216.

At step 1220, the reward management system 211 selects SC based on consumer target interest and profile 1225. Selected SC transmitted to consumer via consumer interface 400.

At step 1235, the consumer may choose to engage with the SC via consumer interface 400 or not. If consumer chooses not to engage with SC, the reporting system 214 records the log in audit database 295 at step 1236. If consumer engages with. SC, then the smart contract is executed at the step 1240 and SC system updates transaction database 299. At step 1250, the transaction feedback from all parties requested and stored in reputation database 270.

In accordance with embodiments of the invention, there are many methods by which the pro of the system may generate revenue. In one embodiment, a flat fee is charged for every SC that is submitted. There may also be flat fees for a predetermined number of SCs submitted within a given period of time, thereby allowing enterprise to subscribe to the service much in the same manner as they might subscribe to a newspaper.

In another embodiment, the decentralized controller 200 calculates an amount paid by enterprise or received by consumers. Upon calculation, the decentralized controller 200 may actuate a program to retain that amount. Alternatively, methods and apparatuses of the present invention may be deployed without a payment feature.

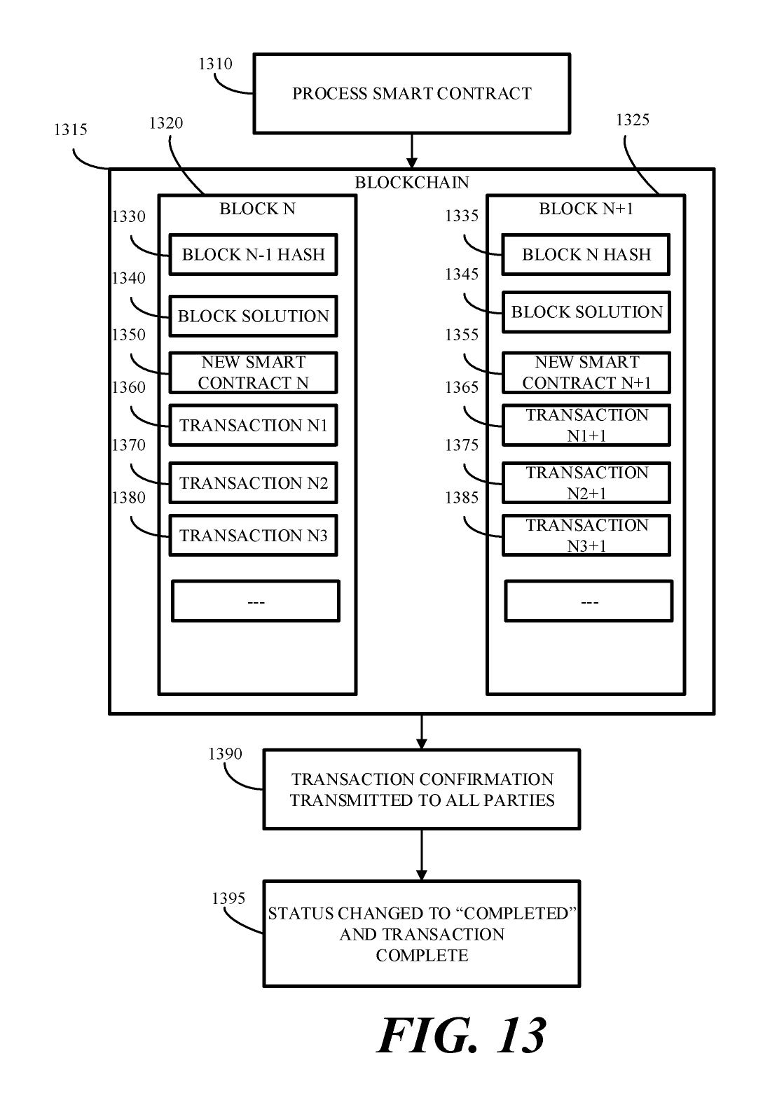

Turning now to FIG. 13, illustrated there are the remaining steps of smart contract process completion. At step 1310, smart contract information and an approval code are processed by clearing system 213 and transmitted to the Blockchain ledger 1315, which is a conceptual illustration of a Blockchain ledger file structure in accordance with embodiments.

In many embodiments, the Blockchain ledger segment 1315 contains a first block N 1320 and a subsequent block N+1 1325. In a number of embodiments, each block contains a hash of the previous block in the chain. The block N hash 1330 contains a hash depending on the previous block N-1 in the Blockchain ledger 1315, while the block N+1 hash 1335 also depends on the previous block N in the Blockchain ledger 1315. Block N also contains a block N hash solution 1340 which is a calculated solution to a cryptographic challenge. Each completed black requires a solution, including block N+1 1325 which contains a block N+1 hash solution 1345 and is not yet linked to a newer block in the current Blockchain ledger 1315. Techniques for managing Blockchain ledgers in the context of currency are described in “Bitcoin: A Peer-to-Peer Electronic Cash System” by Satoshi Nakamoto, published in 2008, the disclosure of which relevant to Blockchain ledger structure is hereby incorporated by reference n its entirety.

In many embodiments, a new smart contract may be registered into a block in the ledger. In block 1320, new smart contract 1350 is entered in. In many embodiments of the invention, each new smart contract entry is unique to a specific CE so that new smart contract 1350 and new smart contract N+1 1355 reference different CEs. Block 1320 also includes a group of transactions, transaction N1 1360, transaction N2 1370, and transaction N3 1380. Likewise, block N+1 1325 has a separate group of transactions N1+1 1365, transaction N2+1 1375, and transaction N3+1 1385. In further embodiments, these transactions are discrete and not necessarily coupled with the new smart contract being registered or with each other.

Transactions represent various types of rewards concerning a smart contract and can be stored in a block as entries, each having a transaction identifier (ID). As will be discussed further below, one or more transactions may be grouped for entry into a block before the block is closed. The transaction may be entered by a clearing system 213 when SC rewards are distributed. A transaction may be digitally signed using a private key over all or a portion of the reward of the transaction.

At the step 1390, the decentralized controller 200 sends transaction confirmation 130 to the enterprise and the consumer. At step 1395, the status of the smart contract is changed to “completed” and the transaction is complete.

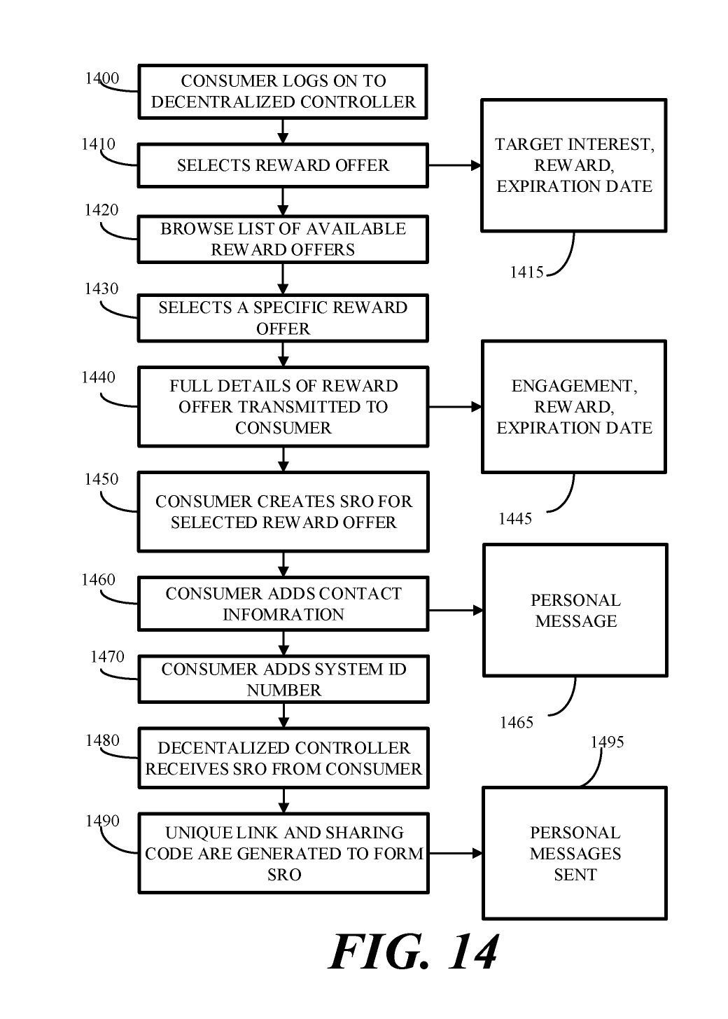

Turning now to FIG. 14, illustrated therein is one method by which a consumer shares reward offers with his or her social network in accordance with embodiments of the invention. At step 1400, the consumer logs on to the decentralized controller 200 using the consumer interface 400, thereby establishing a communication link with the decentralized controller 200 It should be noted that the consumer may be any of an individual, a corporation, a partnership, a government, or other entity. In one embodiment, the decentralized controller 200 has a page on the World Wide Web, thereby allowing the consumer to share reward offer through the interface of conventional web browser software such as Internet Explorer, manufactured by Microsoft Corporation. In another embodiment, the decentralized controller 200 has a display screen on a mobile device, allowing the consumer to share reward offers through the interface on the mobile device. Yet, in another embodiment, the decentralized controller 200 has application programming interface (API) allow 3^{rd} party application developers to access and share reward offers through the 3^{rd} party applications,

At step 1410, the consumer selects an appropriate reward offer using reward offer query 118. A consumer, for example, liked new fashion promotion she saw and engaged with and thinks her friends on social network would also like it. At step 1420, this consumer browses the list of reward offers she have seen. Reward offer may be listed with minimal details, with additional information available only where the consumer requests such information. A new fashion promotion might be listed as “New fall fashion—$0.25—Nov. 1, 2017” As shown in box 1415, the consumer may search reward offer in accordance with a multitude of parameters. These parameters may include target interest, reward, expiration date, and so forth.

At step 1430 the consumer selects a specific reward offer. Where additional information is required, the consumer may request such additional data at step 1440. In one embodiment, each reward offer listing is hyperlinked to a separate web page that provides complete offer details. This detail may include a video or picture of the promotion, special pricing, reward for sharing, expiration date, and so forth. In another embodiment, reward offer details are electronically transmitted directly to the consumer. Transmission means include electronic mail, fax, telephone, beeper, or other communication devices.

As indicated in box 1445, the reward offer may include a promotional video, a reward for sharing, an expiration date, or other terms that constitute conditions or covenants of the reward offer. Such conditions may have been defined when the reward offer was issued.

In one embodiment, the reward management system 211 provides consumers with an accurate details of the specific offer.

At step 1450, the consumer chooses to share reward offer with his or her social network, thus creating shared reward offer or SRO. After the necessary information has been provided, a form is displayed on the video monitor 430 of the consumer interface 400. This form is an electronic contract with a number of blanks to be filled out by consumer. Each blank represents a condition of the SRO. The consumer simply fills in the blanks. In another embodiment, the consumer is presented with mobile display 431 on their mobile device.

At step 1460, the consumer adds contact information of the social network friends, if any. In addition to contacts, a personal message 1465 can be attached to SRO.

At step 1470, the consumer attaches his name or a unique system ID number to the SRO. This unique system ID, in one embodiment, is received from decentralized controller 200 when the consumer registers for the service. Alternatively, the unique system ID is chosen by the consumer and then registered with decentralized controller 200 by phone. The decentralized controller 200 maintains a database of consumer unique system ID numbers in the consumer database 255, and issues (or allows) only unique numbers. If less security is required the consumer's block chain address could serve as the unique ID number since it has the advantages of being unique.

The consumer then transmits the identifier to the decentralized controller 200 at step 1480. The consumer does this by clicking a “share” button located on the screen. At step 1490, a unique link and sharing code are generated for SRO and stored in smart contract database 291,

At step 1495, if consumer provided contact information for sharing SRO, the decentralized controller 200 generates personal messages and sends them in the form specified. Transmission means lude electronic mail, postal mail, fax, telephone, beeper, or other communication devices.

As an alternative to a networked interface, such as a World Wide Web-based interface, the consumer may also transmit the SRO data via application programing interface (API), electronic mail, voice mail, facsimile, or postal mail transmissions. With a voice mail embodiment, the consumer calls decentralized controller 200 via telephone and leaves the SRO in audio form. The SRO may be transcribed into digital text at the decentralized controller 200, or may be made available in audio format. In a postal mail embodiment, the decentralized controller 200 acts more like a muter, directing the SRO to the potential consumers, thereby creating multiple copies of the SRO if necessary. The SRO may also be posted to bulletin boards or web pages operated by decentralized controller 200.

In one embodiment, the decentralized controller 200 supports a plurality of transmission methods, allowing for a wide variety of electronic SRO formats. Some formats may be changed, however, before further processing by decentralized controller 200. For instance, the SRO may be transmitted by mail in paper form, or may be scanned-in and digitized using optical character recognition software to create digital text.

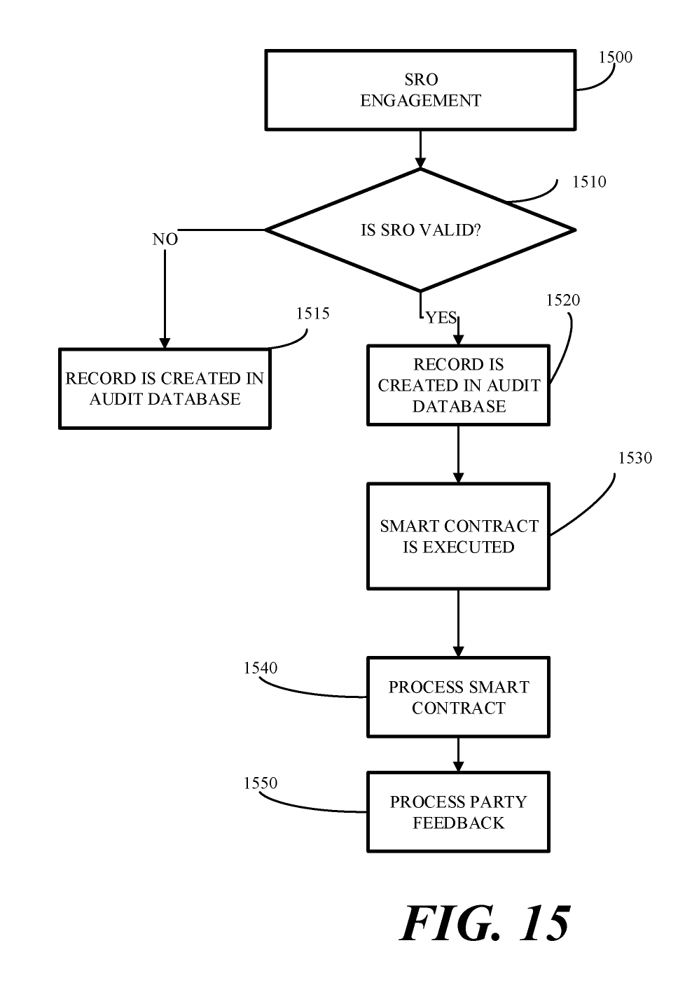

Turning now to FIG. 15, illustrated therein is one embodiment of a SRO distribution process in accordance with embodiments of the invention. The SRO distribution process begins at SRO engagement step 1500. The decentralized controller 200 checks the validity of the SRO at step 1510. The decentralized controller 200 check SRO validity against information stored in smart contract database 291. SRO fails validation if it is not matched with information stored in smart contract database 291, or when enterprise budget is exhausted, or when the SRO reached the expiration date.

At step 1515, reporting 214 records the log of engagement in audit database 295 that SRO is not valid.

At step 1520, reporting system 214 records the log of engagement in audit database 295 that SRO is valid. The smart contract is executed at the step 1530 and SC system updates transaction database 299. In one embodiment, the consumer who engaged with SRO will be rewarded base on the reward structure designated by enterprise in the original SC. At that time, the consumer that shared the original SC via SRO might be rewarded as well. All rewards promises are stored in the smart contract and rewards are distributed by clearing system 213 when at step 1540 when smart contract is processed and transaction is completed.

At step 1540, smart contract information and an approval code are processed by clearing system 213 and transmitted to the Blockchain ledger as previously illustrated in FIG. 13, which is a conceptual illustration of a Blockchain ledger file structure in accordance with embodiments.

At step 1550, the transaction feedback from all parties is requested and stored in reputation database 270.

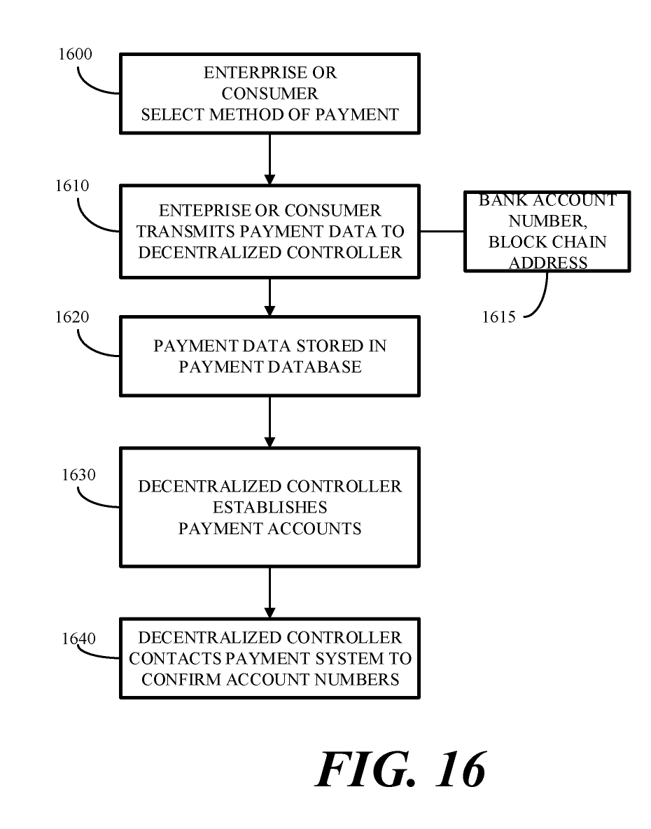

Turning now to FIG. 16, illustrated therein is one embodiment of a method by which the decentralized controller 200 establishes the account database 276 in accordance with the invention. At step 1600, the enterprise or consumer selects his preferred method of payment. Preferred methods might include personal checks, electronic bank funds transfer, digital money, virtual coin and so forth. At step 1610, the enterprise or consumer transmits payment data corresponding to his preferred method of payment to the decentralized controller 200. As indicated at step 1615, such payment data might include bank account number or block chain address. These payment methods are merely illustrative. It will be clear to those of ordinary skill in the art having the benefit of this disclosure that many equivalent payment methods may also be used. If the enterprise or consumer wants to pay by debit card, for example, payment data would include his debit card account number, expiration date, name on the card, and security pin. For electronic funds transfer, payment data includes bank information and an account number. At step 1620, the decentralized controller 200 stores payment data and payment preferences in payment database 285.

At step 1630, the decentralized controller 200 establishes the payment account in account database. These databases are used to store money or virtual coins transferred by the enterprise or consumer. The databases may include a pointer to an account belonging to the enterprise or consumer that exists outside the system. The enterprise or consumer may transfer money to the decentralized controller 200 to be stored in account database 276, which would operate like a conventional checking account. The decentralized controller 200 sends a check to another party that is written against the specific account in account database 276. Alternatively, the decentralized controller 200 may electronically move the funds directly from the enterprise or consumer account database 276 to the other party in account database 276.

At step 1640, the decentralized controller 200 contacts the payment system to confirm that account numbers are valid. Account information may also be embedded in the SC thereby allowing the decentralized controller 200 to complete transaction once smart contracts are completed.

Another method of payment involves procedures using digital cash. The decentralized controller 200 looks up the account's electronic delivery address in the payment database 285, This address is transmitted to the clearing system 213, with the digital cash being downloaded from the account. The decentralized controller 200 updates the payment database 285 to indicate that payment has been made. This address might be an electronic mail address if the digital cash is to be transferred by electronic mail, or it may alternatively be an Internet Protocol address. capable of accepting an on-line transfer of digital cash. This electronic delivery address is sent to the clearing system 213. The digital cash is downloaded to the account database 276. The decentralized controller 200 then updates payment database 285 to indicate that payment has been made. Using these digital cash protocols, it is possible to include payment along with SC in electronic form. The practice of using digital cash protocols to effect payment is well known in the art and need not be described here in detail. For reference, refer to Daniel C. Lynch and Leslie Lundquist, Digital Money, John Wiley & Sons, 1996; or Seth Godin, Presenting Digital Cash, Sams Net Publishing, 1995.

Another method of payment involves procedures using virtual coin. The decentralized controller 200 looks up the account's Blockchain hash address in the payment database 285. This address is transmitted to the clearing system 213, with the virtual coin being sent from the account. The decentralized controller 200 updates the payment database 285 to indicate that payment has been made. This address is digital senders hash on the Blockchain. This electronic delivery address is sent to the clearing system 213. The virtual coin is deposited to the account database 276. The decentralized controller 200 then updates payment database 285 to indicate that payment has been made. Using these distributed Blockchain ledger protocols, it is possible to include payment along with SC in electronic form. The practice of using distributed Blockchain ledger protocols to effect payment is well known in the art and need not be described here in detail. Techniques for managing Blockchain in the context of currency are described in “Bitcoin: A Peer-to-Peer Electronic Cash System” by Satoshi Nakamoto, published in 2008, the disclosure a which relevant to Blockchain structure is hereby incorporated by reference in its entirety.

While the networked, on-line embodiments of the invention describe a protocol in which payments made immediately upon executing a SC, other embodiments may be implemented where payment is delayed until the entire SC has been completed. Alternatively, payment may be delayed until some predetermined date. Partial payments and installment payments are also supported by the system.

The escrow account database 277 allows payment to be delayed until the SC is completed. This delay may occur while the enterprise completes executing of the SC in entirety. The decentralized controller 200 establishes records in the escrow account database 277 as temporary holding records. When the enterprise makes an execution commitment for SC, funds are transferred from the account database 276 to the escrow account database 277. Only after the enterprise completes execution of the SC are funds transferred from escrow account database 277 to account database 276. On the other hand, when the enterprise accepts participation in a SC, funds are transferred from the account database 276 to the escrow account database 277. Only after the enterprise completes execution of the SC are funds transferred from escrow account database 277 to account database 276.

In another embodiment, the enterprise males a partial payment when the commitment is made for a SC. The enterprise then completes payment when the SC is completed. The fraction of the total budget of the SC, in one embodiment, is to be paid upon binding the smart contract. The amount is stored in the payment database 285 when the smart contract is bound. The decentralized controller 200 releases this portion of the funds at step 1170, and then releases the remaining portion after the SC is completed at step 1215. The partial payment made may be non-refundable.

In similar way, the enterprise makes a partial payment when the CE 119 for a SC is made. The enterprise then completes payment when the SC is completed. The fraction of the offered reward of the SC, in one embodiment, is to be paid upon executing CE 119. The reward is stored in the reward database 268 when the CE 119 is bound. The decentralized controller 200 releases this portion of the funds at step 1240, and then releases the remaining portion after the SC is completed at step 1215. The partial payment made may be non-refundable. This would allow the decentralized controller 200, for example, to accept other CE 119.

In yet another embodiment, the execution commitment 120 describes the use of installment payments. The first payment is made when execution commitment 120 is bound, followed by regular payments as specified in the conditions of the SC. The dates at which payments are to be made are stored in the payment database 285.

In one embodiment of the present invention, enterprises respond to the SC not by executing it, but by making a counteroffer with modified and/or additional conditions. An enterprise, for example, might view a SC offered at two dollars per engagement with one thousand dollars budget. The enterprise may be willing to make distribution commitment for one dollar per engagement. As such, rather than passing on the SC, the enterprise may wish to issue a counteroffer. This counteroffer is similar to the SC except for the fact that the enterprise is binding the consumer instead of the consumer binding the enterprise. The counteroffer is also directed to a specific party (the consumer).

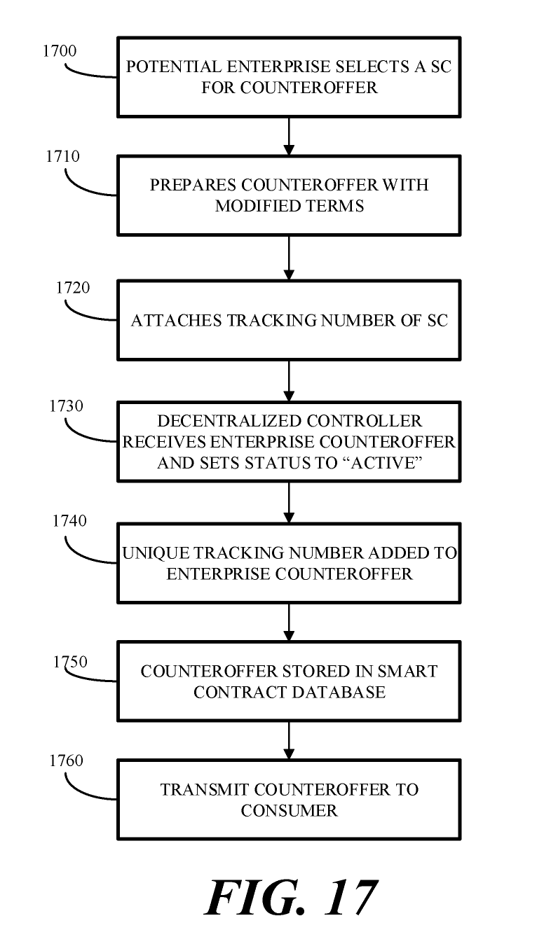

Turning now to FIG. 17, illustrated therein is a method for developing a counter offer in accordance with embodiments of the invention. At step 1700, the potential enterprise selects a SC for which he wishes to make a counteroffer. At step 1710, the enterprise prepares the counteroffer with modified condition& The enterprise follows the same process that the consumer uses to generate the SC, as set forth in steps 500 through 590 of FIG. 5, selecting the terms and conditions as appropriate. Alternatively, the enterprise may be presented with an electronic copy 4 the initial SC. The enterprise may then be allowed to edit those conditions that the enterprise wants to change. For example, the enterprise might take the consumer request for two dollars per engagement and counteroffer with one dollar,

At step 1720, the enterprise attaches the tracking number of the SC to enterprise counteroffer. The decentralized controller 200 receives the enterprise counteroffer at step 1730, setting the status to “active.” The decentralized controller 200 then adds a unique tracking number to enterprise counteroffer at step 1740, and stores the counteroffer in the smart contract database 291 at step 1750. The decentralized controller 200 then extracts the tracking number of the SC attached to enterprise counteroffer to determine to which consumer the enterprise counteroffer should be transmitted at step 1760.

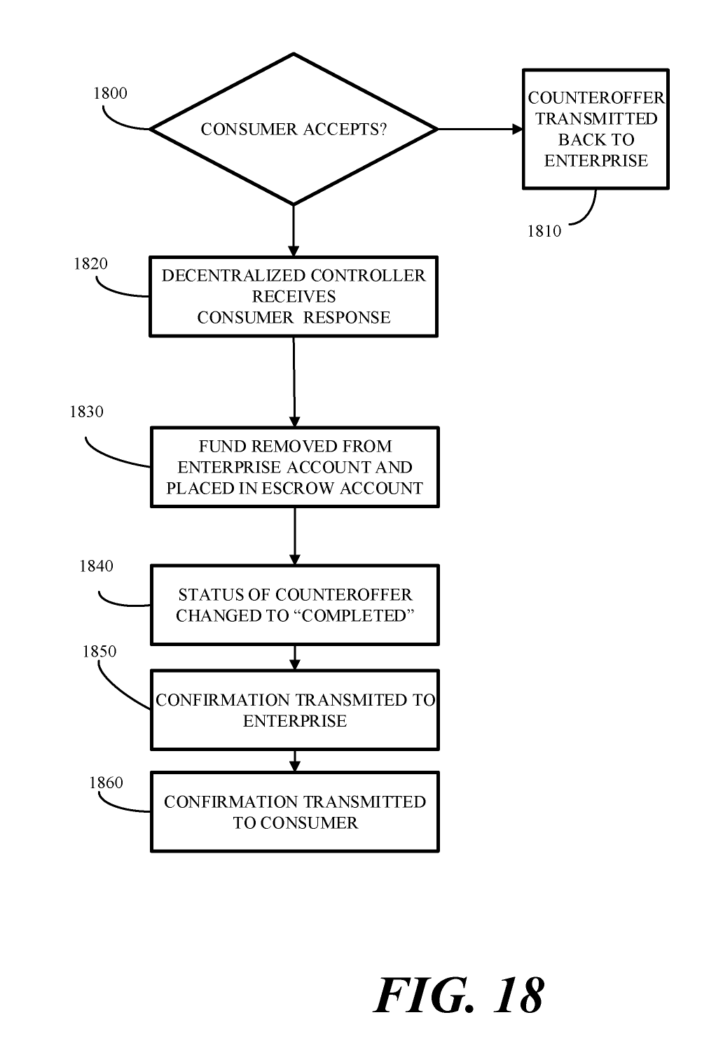

Turning now to FIG. 18, illustrated therein by which the consumer responds to enterprise counteroffer in accordance with the invention. At step 1800, the consumer decides whether to accept the enterprise counteroffer. If he does not accept, the enterprise counteroffer is transmitted back to the enterprise at step 1810. If the consumer does decide to accept, a consumer acceptance 107 is transmitted to the decentralized controller 200 at step 1820. At step 1830 funds are removed from account database 276 and placed in escrow account database 277. At step 1840, the status of enterprise counteroffer is changed to “completed.” Transaction confirmation 130 is then transmitted to the enterprise at step 1850, and on to the consumer at step 1860. Procedures for the completion of SC are described in FIG. 12.

As noted above, in some embodiments of the invention, enterprises and consumers communicate in an off-line manner with decentralized controller 200. Rather than sending electronic mail or using web-based servers, enterprise and consumers use a telephone, fax machine, postal mail, or other off-line communication tool.

A consumer may use a telephone, for example, to generate the SC. In one embodiment, the consumer calls the decentralized controller 200 and is connected with an agent. The consumer provides the terms of the SC, including the personal data, expiration date, and other terms set forth above. The consumer also provides his unique consumer ID, password, or private key so that the decentralized controller 200 can authenticate his identity via the membership system 209. The agent puts this data into digital form by typing it into a terminal and then adds legal language to form the SC. The SC is then transmitted to the decentralized controller 200 where it is made available to potential enterprises as described in the on-line embodiment. In an alternative embodiment, the consumer calls the decentralized controller 200 and is connected with a conventional Interactive Voice Response Unit (IVRU), which allows the consumer to enter some or all of the terms of the SC without the assistance of a live agent.

Potential enterprises may also use a telephone to browse SCs, or to make enterprise execution commitments 120. The potential enterprise calls the decentralized controller 200 and selects a target interests. The decentralized controller 200 then converts the text of each SC into audio form, reading the entire list to the potential enterprise. At any time during the reading of the SCs, the potential enterprise may press a combination of keys on his telephone to select a SC for distribution commitment. The enterprise enters enterprise ID number and is authenticated by the decentralized controller 200 using the membership system 209 prior to making an execution commitment 120. Potential enterprise may also enter parameters before having the list of SCs read to them. An enterprise, for example, might request that all SCs for less than one dollar per engagement be read, skipping any SC with a higher amount. Consumers and enterprises may also communicate with an agent at the decentralized controller 200 through faxes or postal mail. The agent receives the message and proceeds to digitize it and form SC as described above.

In the previous embodiments, authentication of the consumer and enterprise involves checking the attached ID or name and comparing it with those stored in the enterprise database 260 and consumer database 255. Although this procedure works well in a low security environment, it can be significantly improved through the use of cryptographic protocols. These protocols not only enhance the ability to authenticate the sender of a message, but also serve to verify the integrity of the message itself. Such techniques shall be referred to generally as cryptographic assurance methods, and will include the use of both symmetric and asymmetric keys as well as digital signatures and hash algorithms.

The practice of using cryptographic protocols to ensure the authenticity of senders, as well as the integrity of messages, is well known in the art and need not be described here in detail. For reference, refer to Bruce Schneier, Applied Cryptography, Protocols, Algorithms, And Source Code In C, (2d Ed, John Wiley & Sons, Inc., 1996).

Where using cryptographic protocols, all messages between the decentralized controller 200 and the enterprise interface 300 or consumer interface 400 may be authenticated and encrypted using well methods and software. For example, when the decentralized controller 200 is configured as a web server, conventional communications software such as the Internet Explorer web browser from Microsoft Corporation may be used to secure exchange messages between the decentralized controller 200 and the enterprise interface 300 or consumer interface 400.

As mentioned previously, embodiments of the present invention may provide anonymity for all enterprises and consumers. Such anonymity, in one embodiment, is accomplished by eliminating all references to the names of the individuals and businesses for all transactions. An enterprise, for example, may include his unique ID number in the SC rather than his name, thereby preventing the enterprise receiving the SC from discovering the enterprise's identity. This is desirable where the enterprise, for example, does not want his competition to find out about the enterprise campaign. In a similar manner, consumers may also want to keep their identity a secret. A consumer might not want the public to know that they like reward offers from a specific enterprise.

Although using unique ID numbers can provide anonymity, security is heightened when the unique ID numbers are encrypted with a private key of the decentralized controller 200. In such an embodiment, anonymity is protected even where a database is stolen.

Alternate embodiments for anonymity include telephone messaging. When talking on the telephone, the identity of the enterprise and consumer could be hidden using conventional voice modification techniques. If the SC or enterprise execution commitment is in paper form, the form could be scanned using optical character recognition and translated into digital form, discarding any information that could be found in the original document.

Not all transactions require the transfer of money from the enterprise and consumer or vice versa. In a barter transaction, the distinction between the enterprise d consumer disappears, resulting in a contract for exchange between a first party and a second party. The first party posts the SC with a barter commitment to it. Instead of receiving c shy the other parties product samples.

Although the previous embodiments have described the engagement of consumer by enterprise, and also the delivery of money from enterprise to consumer, there will inevitably be disputes arising from some transactions, requiring follow-up activity to resolve these disputes. The present invention can support dispute resolution in two ways.

First, language may be included—perhaps as boilerplate or form language—into every SC. This language, in one embodiment, requires that both parties submit to binding arbitration of all disputes. Binding arbitration helps to avoid more costly and time-consuming legal battles. Additionally, liquidated damages may be set which specify damage amounts for particular infractions of the SC.

Second, the decentralized controller 200 can support the arbitration process by providing an arbiter for each dispute. Such arbitration might be required when consumer's engagement in the SC provided by the enterprise does not act in accordance with the requirements of the SC. An enterprise seeking consumers who are interested in new fashion, for example, might seek damages against a consumer with fake consumer accounts. Instead of seeking damages, the enterprise may seek a monetary reward, such as rebate or discount on the original SC amount. In an arbitration involving consumer's engagement, the enterprise may submit evidence to the decentralized controller 200 along with the tracking number of the SC 110, thereby allowing the arbiter to establish whether the enterprise and consumer have fulfilled the conditions of the SC.

In an alternative embodiment, transaction ta can be sent to third party arbiters outside the system. The decentralized controller 200 may send a copy of the SC, enterprise execution commitment, tar consumer engagement to the arbiters. Cryptographic keys may also be provided to the arbiters if there are questions of authenticity or non-repudiation.

As illustrated in FIG. 13, the transaction data is stored on the Blockchain d and can be verified by any outside party or system. The Blockchain ledger stores executed enterprise execution commitment, consumer engagement and shared reward offers. Cryptographic keys may be verified if there are questions of authenticity or non-repudiation.

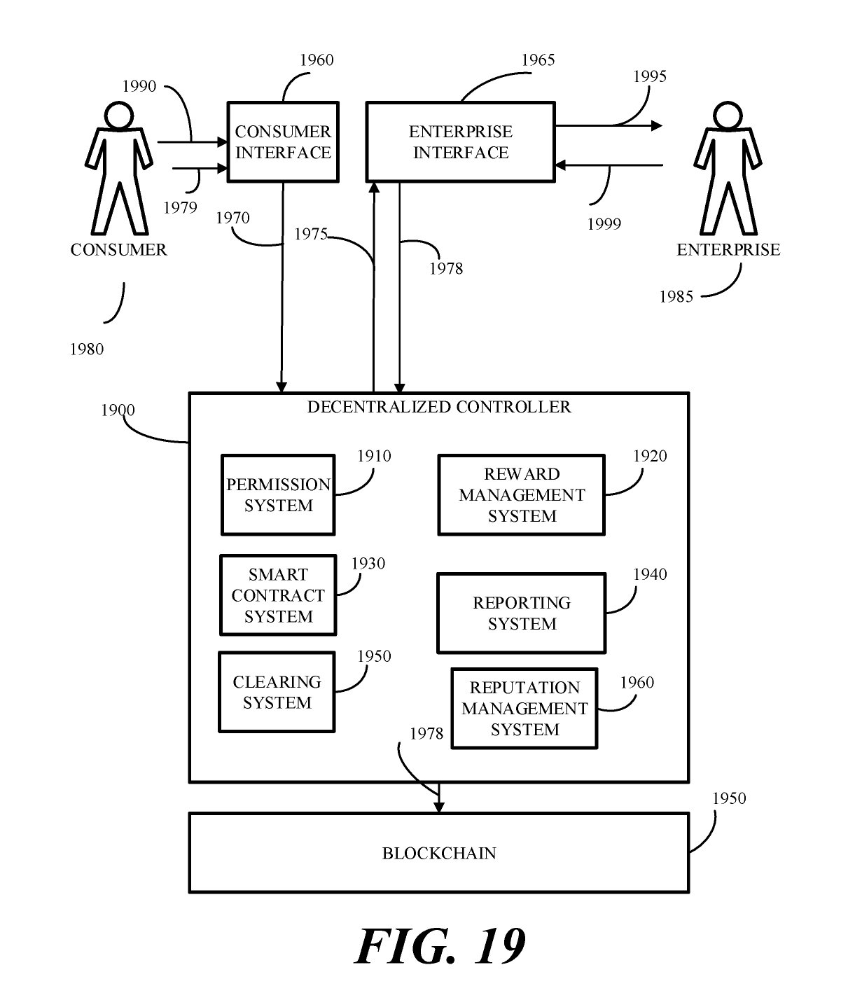

Turning now to FIG. 19, illustrated therein is one embodiment of a schematic block diagram illustrating a method of for decentralized PCP management with reward and reputation in accordance with the invention. As noted above, but illustrated in general form in FIG. 19, in one embodiment, a decentralized controller 1900 includes a permission system 1910, a reward management system 1920, a smart contract system 1930, a reporting system 1940, a clearing system 1950, and a reputation management system 1960. The permission system 1910 is configured to process requests received by the networked, electronic, exchange apparatus for consumer preferences, consent and permissions. The permission system 1910 is further configured to deliver one or more consumers personal data and information response to the requests.

A reward management system 1920 is configured to process enterprise's rewards to consumer for access to consumer personal data. A smart contract system 1930 is configured to process storage and execution of smart contracts between consumer and enterprise. A clearing system 1950 is configured to process financial transactions associated with the smart contract execution. A compliance system 1940 is configured to maintain record of decentralized controller transactions. And a reputation management system 1960 is configured to maintain the reputation and feedback for all transactions processed by decentralized controller.

The consumer 1980 provides personal data, consent and preferences 1990 to consumer interface 1960. The consumer interface 1960 submits the personal data, consent and preferences 1970 to the decentralized controller 1900. In response, the decentralize controller 1900 generates a smart contract 1975 associated with the consumer PCP, and makes the smart contract 1975 available to the enterprise interface 1965. Enterprises 1985 utilize the enterprise interface 1965 to view the smart contract 1975. The enterprises 1985 also use the enterprise interface 1965 to generate execution commitments 1999, which are submitted to the enterprise interface 1965. The enterprise interface 1965 then communicates the execution commitments 1978 to decentralized controller 1900 for processing.

Embodiments of the present invention offer many advantages over prior art of personal data management and promotion targeting consumers. A few of these advantages will be described here.

First, embodiments of the present invention provide enterprises with ability to protect personal data of consumers, and obtaining appropriate consents for using and processing data while keeping records detailing such activity. Second, embodiments of the present invention enable enterprises to deliver the right engagement to the right people at the right time, resulting in a marketing campaign with a high return on investment for the marketer, while broadening the reach of their campaign beyond the immediate target audience by allowing consumers to re-market their favorite promotions via their social networks, where the interaction is tracked and verified, thus avoid potential for fraud and fake clicks.

Next, consumer personal data is securely stored off the public network and anonymized. It can only be accessed and shared with consumer consent and explicit permission that is managed by contracts securely stored on the Blockchain. Shared preferences then can be used by enterprises to provide consumer with custom tailored offers on their terms based on specific profiles and response behaviors, without the costs and challenges associated with building and maintaining their own permission-based data storage technologies. Further, embodiments of the present ate the enormous benefit to the individual enterprise from the scale and reach of the system provides when millions of consumers are connected into one consumers network and the clustering of all network consumers into topics of Wrest, level of engagements, the size of personal and social network and response rate histories.

Forth, embodiments of the present invention provides for consumer's qualitative feedback as they interact with enterprise and their offers and rate the experience, thus creating not only the valuable feedback loop to enterprises but also the scare for enterprise's reputation.

Next, embodiments of the present invention provides for consumers to control the flow of personal data they share and promotional information they receive by explicit giving permission to what data is shared, when, and far how long, and opting in only for the relevant promotions based on their interests and then if liked, to share promotions with their personal and social networks.

Next, embodiments of the present invention benefit consumers by only engaging with promotions from enterprises that are selected by them and targeted to their specific interests with content to inform them about matters such as e.g. new product offerings and special pricing promotions. Consumers use the invention to organize their personal data sharing, subscriptions and permission lists, filter undesired reward offers and control promotion frequency. Additionally, embodiments of the present invention allows consumers to share and forward these promotional messages in their personal and social networks and in return receive proportionate rewards. Consumers become an active marketer within their sphere of influence for self-selected promotions that they recommend, thus creating an implied trust for the value of the promotion shared. Additionally, the quality of sharing arrangement and advertising offers are measured with a feedback system that enables consumer reputation management, the higher is consumer's reputation, the more likely their sharing will be effective.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic system for management of personal data, preferences, consent and permissions, represented by smart contracts stored and executed on a decentralized blockchain ledger, between an enterprise and at least one of a plurality of consumers, comprising of:
a decentralized controller, having a network interface coupled to a network, in which the decentralized controller is comprised of a smart contract system configured to process, create and distribute smart contracts, as well as storing and executing smart contracts on a decentralized blockchain ledger;
a blockchain ledger, coupled to the network interfaces across the network, which is configured to stare and execute smart contracts between an enterprise and at least one of a plurality of consumers;
a consumer interface, coupled to the network interface across the network, which is configured to receive consumer input; and
an enterprise interface, coupled to the network interface across the network, which is configured to receive enterprise input.

2. The electronic system of claim 1, wherein the decentralized controller further comprises of:
a distribution system configured to process consumer requests received by the electronic system to store personal data and create smart contracts on a decentralized blockchain ledger, and to deliver one or more smart contracts in response to the enterprise input, wherein the distribution system is further configured to process execution requests received by the electronic system for smart contracts, and to deliver one or more smart contract choices in response to the execution requests;
a permission management system configured to manage consumers personal data, preferences, consent and permissions;
a clearing system configured to process financial transactions associated with the distribution of the smart contracts;
a reward management system configured to match reward offers based on consumers target interests and delivery of them through the consumer interface;
a reporting system configured to track all activities by a decentralized controller and record them for later access and reporting; and
a smart contract system configured to process requests from consumers to initiate the smart contract, store and execute the smart contract on a blockchain ledger.

3. The electronic system of claim 1, further comprising of a blockchain communication coupling which is creating a network connection between the decentralized controller and a blockchain system, wherein the blockchain system communication coupling is configured to receive smart contracts and transactions created by decentralized controllers and record them for future accesses, validations and executions.

4. The electronic system of claim 1, further comprising of a bank communication coupling via a network connection between the decentralized controller and a bank, wherein the bank communication coupling is configured to receive information validating funds from the bank.

5. The electronic system of claim 1, further comprising of a smart contract validation communication coupling connected across the network between the decentralized controller and a smart contract validation system, wherein the smart contract validation communication coupling is configured to receive information validating consumer smart contracts for compliance with consumer consent, preferences and permissions.

6. The electronic system of claim 1, wherein the decentralized controller further comprises of a membership system, a consumer database and an enterprise database, wherein the membership system is configured to authenticate the identities of at least one consumer and at least one enterprise by matching identities of consumers stored in the consumer database and by matching identities of enterprises stored in the enterprise database.

7. The electronic system of claim 2, further comprising of a smart contract database which is accessible by the decentralized controller which is upon receiving personal data from the consumer interface, is configured to invoke the smart contract system to create a plurality of smart contracts corresponding to the consumers personal data and preferences and reward offer settings and to store them in the smart contract database.

8. The electronic system of claim 7, wherein the decentralized controller, upon receiving a request from the enterprise interface, is configured to invoke the smart contract system to retrieve one or more smart contracts from the smart contracts database, associate a consumer with the one or more smart contract, and to deliver the consumer information to the enterprise interface.

9. The electronic system of claim 8, further comprising of a plurality of databases which are accessible by the decentralized controller, the plurality of databases comprising of at least a smart contract database for storing execution commitments of the smart contracts, and a transaction database for storing transaction data relating to the smart contracts.

10. The electronic system of claim 9, wherein the decentralized controller, upon receiving a execution commitment from the enterprise interface, is configured to invoke the smart contract system to generate an identifier specifying at least one financial account, the identifier being associated with the execution commitment, and to store the execution commitment and the identifier in the smart contract database.

11. The electronic system of claim 10, wherein the decentralized controller, upon the execution of the smart contract stored in the smart contract database, is configured to invoke the clearing system to transfer funds from an enterprise account to consumer account based on a reward structure which is stored in the smart contract and record the execution of a smart contract on a decentralized blockchain ledger.

12. The electronic system of claim 9, further comprising of a plurality of databases, containing at least a permissions database, a reward offer database, a reputation database, a rewards database, a payment database, an audit database, an escrow database, and a smart contract database.

13. A method for management of personal data, preferences, consent and permissions, represented by smart contracts, stored and executed on a decentralized blockchain ledger, between an enterprise and at least one of a plurality of consumers, the method comprising the steps of:
providing a networked, electronic change apparatus having a decentralized controller, in which the decentralized controller is comprising of:
a smart contract management system configured to process requests received by the networked, electronic exchange apparatus for smart contracts, and to deliver one or more smart contracts in response to the requests;
a blockchain ledger configured to store and execute smart contracts between au enterprise and at least one of a plurality of consumers;
a permission system configured to process requests by consumers to store personal data, preferences, consent and permissions;
a reputation management system configured to maintain feedback records of decentralized controller transactions;
a clearing system configured to process financial transactions associated with the rewards of the smart contracts;
a reporting system configured to maintain a record of decentralized controller transactions and consumer data accesses;
a consumer interface; and
an enterprise interface;
receiving personal data from the consumer interface, the personal data comprising at least an email, name, permissions, consent, and preferences;
generating a smart contract associated with the personal data;
delivering the smart contract to the enterprise interface; and
storing and executing the smart contract on a decentralized blockchain ledger.

14. The method of claim 13, wherein the smart contract corresponds to a consumer personal data, further comprising the step of a partial sharing of personal data, consent to the reward for engagement with at least one of the plurality of enterprises.

15. The method of claim 13, further comprising of the steps to:
receive at least one smart contract from the consumer interface in response to the step of delivering the reward offer;
receive at least one execution commitment from the enterprise response to the step of delivering the smart contract;
receive an electronic financial account identifier associated with each execution commitment from the enterprise interface; and
execute an electronic transfer of funds via the electronic financial account identifier; and
execute and record a smart contract on a decentralized blockchain ledger.

16. The method of claim 15, wherein the smart contract comprises of at least the personal data shared, consent, list of preferences, permission to access personal data, a reward value, and a contract expiration date.

17. The method of claim 15, further comprising of the step to receive a guarantee for reward payments upon execution of the smart contract, wherein the guaranteed reward is comprised of either a digital currency, cash, reward points or a combination thereof.

18. The method of claim 15, further comprising of the step of determining whether a smart contract duration has expired prior to the execution commitment.

19. The method of claim 15, further comprising of the steps of validating the personal data and validating the at least one execution commitment.

20. The method of claim 15, further comprising the steps of:
delivering at least one smart contract to the consumer interface upon receiving the personal data;
receiving additional personal data, consent, permissions and preferences from the consumer interface
generating, electronically, a first counteroffer and delivering the first counteroffer to the enterprise interface;
executing at least one smart contract upon receiving the at least one execution commitment;
executing and recording a smart contract on a decentralized blockchain ledger;
receiving additional personal data details from the consumer interface; and
generating, electronically, a follow-up counteroffer and delivering the counteroffer to the enterprise interface.
